(19) United States
(12) Patent Application Publication
(10) Pub. No.: US 2026/0238394 A1
(43) Pub. Date: Aug. 13, 2026

(54) PRESERVE ORDERING BETWEEN POSTED, NON-POSTED, AND COMPLETION TRANSACTIONS

(71) Applicant: Intel Corporation, Santa Clara, CA (US)

(72) Inventors: Shalini Sharma, Folsom, CA (US); Scott Constable, Portland, OR (US); Raghunandan Makaram, Northborough, MA (US); Christopher Van Beek, Cornelius, OR (US)

(21) Appl. No.: 19/342,259

(22) Filed: Sep. 26, 2025

Related U.S. Application Data
(60) Provisional application No. 63/755,827, filed on Feb. 7, 2025.

(51) Int. Cl. H04L 1/1829; G06F 11/07; G06F 13/40

(52) U.S. Cl. CPC H04L 1/1841; G06F 11/076; G06F 13/4022; G06F 2213/0026

(57) ABSTRACT

Systems, methods, and apparatuses to detect reordering issues are described. In some examples, a system comprises a first Peripheral Component Interconnect Express (PCIe) device to transmit transaction layer packets (TLPs) and integrity and data encryption sync (IDE_SYNC) messages to a second PCIe device; and the second PCIe device to receive the TLPs and IDE_SYNC messages, wherein the second PCIe device is to perform at least one of a detection of a TLP reordering by a PCIe fabric based at least in part on when an IDE_SYNC message is received and/or a detection of an TLP ordering error when a TLP is received before a IDE_SYNC message that preceded it.

### BACKGROUND

Peripheral Component Interconnect Express (PCI Express or PCIe) is a serial computer expansion bus standard that is commonly used for graphics cards, hard drive adapters, etc.

### BRIEF DESCRIPTION OF DRAWINGS

Various examples in accordance with the present disclosure will be described with reference to the drawings, in which:

FIG. 1 illustrates examples of a PCIe topology.

FIG. 2 illustrates examples of TLP packet.

FIG. 3 illustrates examples of IDE usage.

FIG. 4 illustrates examples of an IDE prefix.

FIGS. 5-6 illustrate examples of IDE_SYNC messages.

FIG. 7 illustrates examples of entities.

FIG. 8 illustrates examples of a state machine for the NP tracker.

FIG. 9 illustrates examples of a method to be performed by a transmitter and receiver.

FIG. 10 illustrates an example computing system.

FIG. 11 illustrates a block diagram of an example processor and/or System on a Chip (SoC) that may have one or more cores and an integrated memory controller.

FIG. 12 is a block diagram illustrating a computing system 1200 configured to implement one or more aspects of the examples described herein.

FIG. 13A illustrates examples of a parallel processor.

FIG. 13B illustrates examples of a block diagram of a partition unit.

FIG. 13C illustrates examples of a block diagram of a processing cluster within a parallel processing unit.

FIG. 13D illustrates examples of a graphics multiprocessor in which the graphics multiprocessor couples with the pipeline manager of the processing cluster.

FIGS. 14A-14C illustrate additional graphics multiprocessors, according to examples.

FIG. 15 shows a parallel compute system according to some examples.

FIGS. 16A-16B illustrate a hybrid logical/physical view of a disaggregated parallel processor, according to examples described herein.

FIG. 17(A) is a block diagram illustrating both an example in-order pipeline and an example register renaming, out-of-order issue/execution pipeline according to examples.

FIG. 17(B) is a block diagram illustrating both an example in-order architecture core and an example register renaming, out-of-order issue/execution architecture core to be included in a processor according to examples.

FIG. 18 illustrates examples of execution unit(s) circuitry, such as execution unit(s) circuitry.

FIG. 19 is a block diagram of a register architecture according to some examples.

FIGS. 20A-20B illustrate thread execution logic including an array of processing elements employed in a graphics processor core according to examples described herein.

FIG. 21 illustrates an additional execution unit, according to an example.

FIG. 22 is a block diagram illustrating a graphics processor instruction formats 2200 according to some examples.

FIG. 23 is a block diagram of another example of a graphics processor.

FIG. 24A is a block diagram illustrating a graphics processor command format according to some examples.

FIG. 24B is a block diagram illustrating a graphics processor command sequence according to an example.

FIG. 25 is a block diagram illustrating the use of a software instruction converter to convert binary instructions in a source ISA to binary instructions in a target ISA according to examples.

FIG. 26 is a block diagram illustrating an IP core development system 2600 that may be used to manufacture an integrated circuit to perform operations according to some examples.

### DETAILED DESCRIPTION

The present disclosure relates to methods, apparatus, systems, and non-transitory computer-readable storage media for preserving ordering between posted, non-posted, and completion transactions.

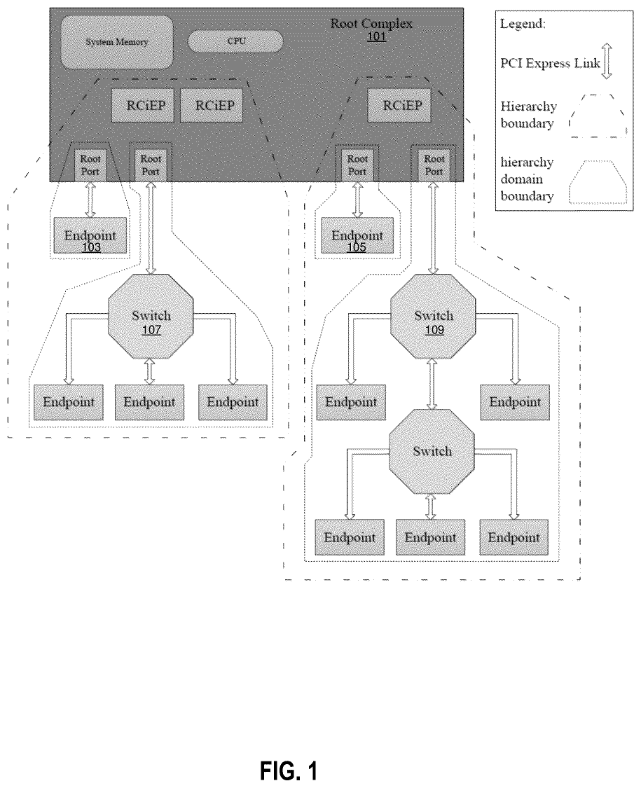

FIG. 1 illustrates examples of a PCIe topology. A PCIe fabric is composed of one or more point-to-point links that interconnect a set of components. In the illustration of FIG. 1 the fabric has a root complex (RC) 101 that is coupled to a plurality of endpoints (e.g., endpoints 103 and 105) and a plurality of switches (e.g., switches 107 and 109). The connections between these entities are PCIe links. Examples of endpoints include, but are not limited to: graphics cards, accelerator cards, storage controllers, RAID controllers, etc.

The RC 101 is the root of the input/output (I/O) hierarchy that connects a subsystem (e.g., CPU, GPU, accelerator, memory, etc.) to I/O. A RC may support one or more PCIe ports. Each interface defines a separate hierarchy domain. Each hierarchy domain may be composed of a single Endpoint or a sub-hierarchy containing one or more switches and endpoints. A RC may also have root complex integrated endpoints (RCiEPs).

PCIe uses three logical layers: a transaction layer, a data link layer, and a physical layer. Each of the logical layers has two sections: one that processes outbound information and one that processes inbound information.

PCI Express uses packets to communicate information between components. Packets are formed in the Transaction and Data Link Layers to carry the information from the transmitting component to the receiving component. As the transmitted packets flow through the other layers, they are extended with additional information necessary to handle packets at those layers. At the receiving side the reverse process occurs, and packets get transformed from their Physical Layer representation to the Data Link Layer representation and finally (for Transaction Layer Packets (TLPs) to the form that can be processed by the Transaction Layer of the receiving device.

The Transaction Layer's primary responsibility is the assembly and disassembly of TLPs. TLPs are used to communicate transactions, such as read and write, as well as certain types of events. The Transaction Layer is also responsible for managing credit-based flow control for TLPs.

Every request packet requiring a response packet is implemented as a Split Transaction. Each packet has a unique identifier that enables response packets to be directed to the correct originator. The packet format supports different forms of addressing depending on the type of the transaction (Memory, I/O, Configuration, and Message). The Packets may also have attributes such as No Snoop, Relaxed Ordering, and ID-Based Ordering (IDO).

The Transaction Layer supports four address spaces: it includes the three PCI address spaces (memory, I/O, and configuration) and adds a message space.

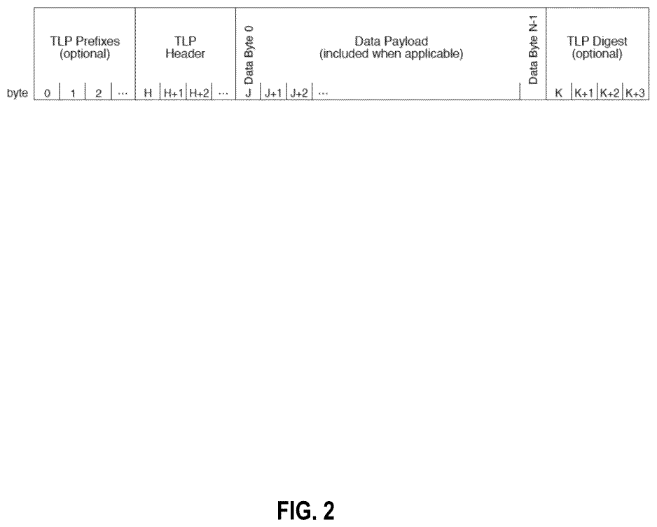

FIG. 2 illustrates examples of TLP packet. Transactions consist of Requests and Completions, which are communicated using packets. Completions are used only where required, for example, to return read data, or to acknowledge Completion of I/O and Configuration Write Transactions. All UIO Requests require Completions. Completions are associated with their corresponding Requests by the value in the Transaction ID field of the Packet header. A TLP packet consists of one or more optional TLP Prefixes, a TLP header, a data payload (for some types of packets), and an optional TLP Digest. Examples of TLP types include memory read requests, I/O read requests, I/O write requests, configuration read and/or write requests, completions, message requests with or without payloads (such as IDE_SYNC or IDE_FAIL messages), etc.

Some examples of PCIe allow for integrity and data encryption (IDE) that provides confidentiality, integrity, and replay protection for TLPs transmitted and received between two ports. IDE cryptographic mechanisms can be extended as security requirements evolve. The security model considers threats from physical attacks on links, including cases where an adversary uses lab equipment, purpose-built interposers, malicious extension Devices, etc. to examine data intended to be confidential, modify TLP contents, reorder and/or delete TLPs. TLPs can be secured as they transit switches, extending the security model to address attacks mounted by reprogramming Switch routing mechanisms, or using “malicious” switches. IDE can be used to secure traffic within trusted execution environments, also known as trust domains, composed of multiple components.

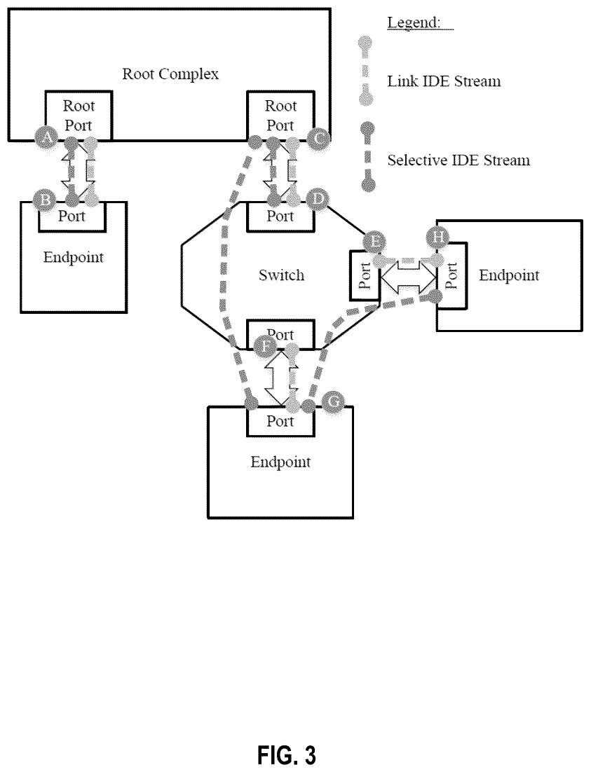

IDE establishes an IDE stream between two ports as shown in FIG. 3. There are two types of IDE streams: a selective IDE stream applies to selected TLPs as determined by association rules and a link IDE stream applies to all TLPs Transmitted using a particular TC except those that are associated with a selective IDE stream. When there are no switches between the ports, then it is possible to secure all, or only selected, TLP traffic on the link, using link IDE or selective IDE, respectively.

There is no required relationship, or restriction, between Link IDE and Selective IDE. It is possible to use both Link IDE and Selective IDE between two directly connected Ports, as shown between Ports A and B, in which case TLPs associated with the Selective IDE Stream are secured using that Stream's key set, and all other TLPs are secured using the key set for the Link IDE Stream. Such a configuration may be desirable if, for example, different security policies are applied to the Selective IDE TLPs than to other Link traffic.

It is possible to use Selective IDE in cases where the IDE Terminus is a Switch Port, as shown between Ports C and D. IDE does not establish security beyond the boundary of the two terminal Ports, and mechanisms for securing and/or isolating secure traffic within a Component are outside the scope of this document. Again, referring to the example shown, the Selective IDE Streams between Ports C and G, and between Ports G and H, are secured as they pass through the Switch. All other Link IDE and Selective IDE streams illustrated are secured by IDE from Port to Port, but must be secured by implementation specific means within the Component past the terminal Port. By implication, when Link IDE is used with TLPs flowing “hop-by-hop” through one or more Switches, it is necessary to ensure acceptable security is maintained within the Switch(es), but how this is done is outside the scope of this document.

In addition to the in-line securing of TLPs, as a “data plane” capability, IDE defines interoperable mechanisms for establishing Streams and programming keys, as a “control plane” capability. For example, for an Endpoint connected directly to the Root Complex (A to B in the figure), one way to establish IDE is to use IDE Key Management via DOE to allow host Firmware/Software to configure the Ports, including securely programming the IDE keys into both Ports. In another example, for two Endpoints communicating peer to peer (G to H in the figure), the two Endpoints can implement communication directly via [MCTP-VDM] and [Secured-MCTP], where one will take the Requester role and the other the Responder role, and then applying the IDE key management (IDE_KM) flow for secure key establishment. In an alternate example, it is also possible for some kind of management controller to apply IDE_KM over a sideband management connection, to program IDE keys in Ports throughout a system.

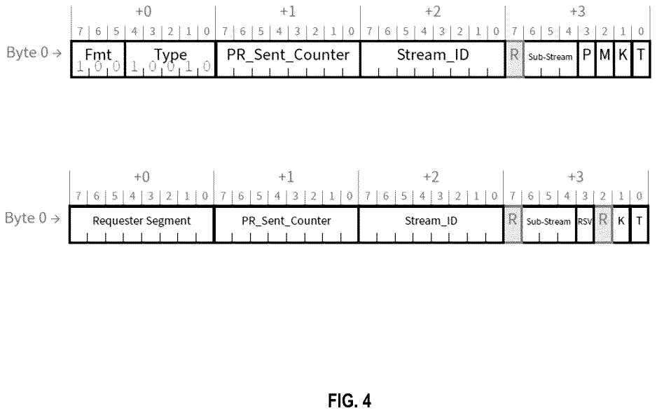

TLPs secured by IDE are called IDE TLPs. In Non-Flit Mode, all IDE TLPs must use the IDE prefix as shown in FIG. 4. This prefix must precede all other End-End TLP prefixes. The prefix includes: a M bit that when set, indicates this TLP includes a MAC; a K bit that indicates the key set used for this TLP; a T bit that when set indicates the TLP originated from within a trusted execution environment; a P bit that when set indicates the TLP includes PCRC; Sub-Stream[2:0] to indicate the Sub-Stream identifier value; a Stream_ID[7:0] to indicate the associated Stream ID value; a PR_Sent_Counter[7:0] that for non-UIO Non-Posted Requests and Completions the value must be determined according rules and is reserved for Posted Requests and for UIO Requests; a type filed, and a format field. Note that a reserved bit (shown as R) is also included in a default IDE prefix.

Also illustrated is an OHC-C information. In some examples, IDE TLPs include OHC-C. If Sub-Stream is 000b, 001b, or 010b, the PR_Sent_Counter, Stream_ID, K, and T fields are meaningful. If Sub-Stream is 011b-110b, receiver behavior is undefined. For IDE Completion TLPs, the Requester Segment field is Reserved and the RSV bit must be Clear.

In PCIe communication, transactions are categorized into three types: Posted (P), Non-Posted (NP), and Completion (C) transactions. The current IDE specification mandates that Non-Posted and Completion transactions must not bypass Posted transactions. To manage this, the transmitter maintains two 8-bit counters: PR_Sent_Counter-NPR and PR_Sent_Counter-CPL. These counters track the number of Posted Requests transmitted since the last Non-Posted Request (NPR) or Completion (CPL), respectively. The rules for updating the posted counters are as follows:
The transmitter increments both counters for each Posted Request transmitted.
When a Non-Posted Request is transmitted:
   The PR_Sent_Counter-NPR value is used in the IDE Prefix.
   The PR_Sent_Counter-NPR is then reset to zero.
When a Completion is transmitted:
   The PR_Sent_Counter-CPL value is used in the IDE Prefix.
   The PR_Sent_Counter-CPL is then reset to zero.
When either counter reaches 245, an IDE Sync message is transmitted, and both counters are reset to zero.

On the receiver side, two 64-bit counters, PR_Received_Counter-NPR and PR_Received_Counter-CPL, are maintained. These counters are incremented for each Posted Request received. When a Non-Posted Request or Completion is received, the corresponding PR_Sent_Counter value is subtracted from the respective PR_Received_Counter, and the counter is updated with the result. If the subtraction underflows, it indicates an error. However, the current PCIe transaction ordering algorithm faces a significant limitation due to the 8-bit size of the transmitter counters and 8-bit size of counters in IDE prefix (NFM)/OHC-C (FM).

The reset mechanism for transmitter counters can lead to a scenario where a Non-Posted Request transmitted immediately after an IDE Sync message is incorrectly reordered before subsequent Posted Requests. This reordering violates the required transaction ordering rules, potentially resulting in data integrity issues and system unreliability.

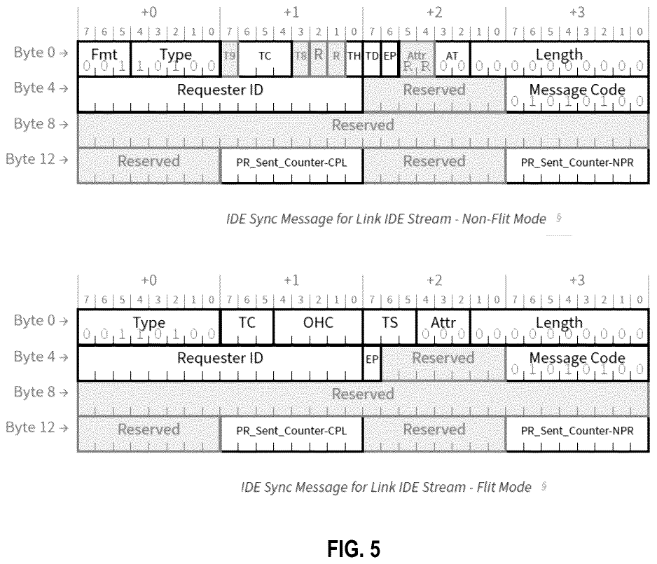

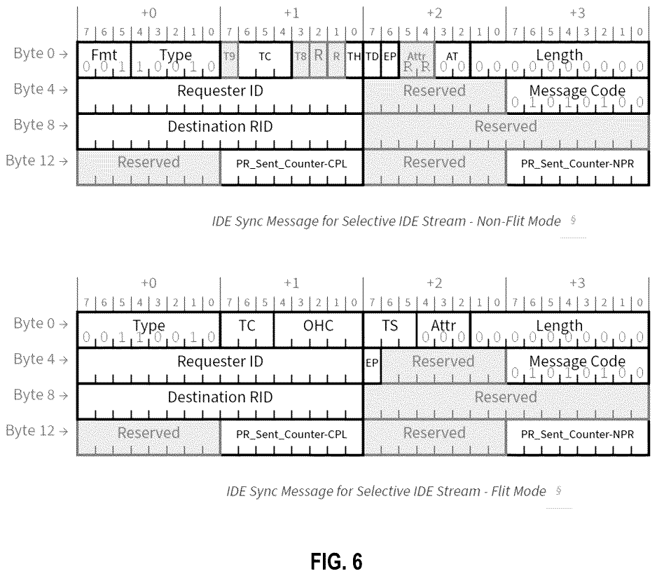

The problem is due to limited range of the 8-bit counters in the IDE prefix (non-flit mode (NFM))/orthogonal header content-C (OHC-C) (flit mode (FM)) and to address the limitation PCIe spec requires transmission of IDE_SYNC message, but the PCIe IDE specifications leaves corner cases that allow re-ordering of non-posted transactions. The IDE_SYNC message is to cause a synchronization of IDE PR count for an associated IDE stream. FIGS. 5-6 illustrate examples of IDE_SYNC messages.

Examples of corner cases are described below.

A first example of a corner case is a transmitter (TX) transmitted 245 posted TLPs and then an IDE_SYNC message is transmitted with count=246 and the Posted counter is reset to 0. If a NP TLP is then transmitted with Posted counter=0, then this NP TLP can be reordered just before any IDE_SYNC Message.

The transmitter transmitted sequence for this example is NP TLP0 (Posted Counter=0) , IDE_SYNC (Posted counter=246), Posted TLP245, . . . , Posted TLP1, Posted TLP0. The switch reordered sequence received at the receiver is IDE_SYNC (Posted counter=246), Posted TLP245, . . . , Posted TLP1, Posted TLP0, NP TLP0 (Posted Counter=0) . In this example NP TLP0 (Posted Counter=0) is reordered ahead of Posted TLP0 without any detection by the receiver and breaking the ordering requirement.

Second example of a corner case is where a receiver missed the detection of re-ordering is as follows. The transmitter transmitted sequence is NP TLP 0 (Posted Counter=0), IDE_SYNC (Posted counter=246), Posted TLP245, . . . , Posted TLP1, Posted TLP0, IDE_SYNC (Posted counter=245), Posted TLP245, . . . , Posted TLP1, Posted TLP0. A switch reordered sequence received at the receiver is IDE_SYNC (Posted counter=246), Posted TLP245, . . . , Posted TLP1, Posted TLP0, NP TLP0 (Posted Counter=0) , IDE_SYNC (Posted counter=245), Posted TLP245, . . . , Posted TLP1, Posted TLP0. Another potential switch reordered sequence received at the receiver is: IDE_SYNC (Posted counter=246), Posted TLP245, . . . , Posted TLP1, Posted TLP0, IDE_SYNC (Posted counter=246), Posted TLP245,. . . ., Posted TLP1, Posted TLP0, NP TLP0 (Posted Counter=0).

A third example of a corner case is where a receiver detects reordering, but the detection occurs late when the IDE_SYNC is received. The first sequence is NP TLP (Posted Counter=2), Posted TLP1, Posted TLP 0, IDE_SYNC (Posted counter=246), Posted TLP 245,. . . ., Posted TLP 1, Posted TLP 0. The second sequence is Posted TLP 1, Posted TLP 0, IDE_SYNC (Posted counter=246), Posted TLP245, . . . , Posted TLP2, NP TLP (Posted Counter=2), Posted TLP1, Posted TLP0. In this case, the posted counter mismatch is detected later when IDE_SYNC is received.

Examples detailed herein attempt to ensure that NP or CPL TLPs cannot be inserted ahead of posted TLPs. Tracking the minimum number of posted TLPs ahead of an NP TLP and/or CPL TLP in the IDE prefix/OHC-C header using large counters that never rollover is a straightforward solution, but it is not optimal for area and performance. As such, a plurality of alternatives is detailed herein.

Some examples deal with the late detection of a reordered NP or CPL TLP. In some of these examples, if an NP TLP or CPL TLP is reordered by the PCIe fabric, the reordering is not immediately detected upon receipt of the NP TLP. Instead, it is eventually detected when the IDE_SYNC is received. This late detection occurs when one or more IDE_SYNCs are in flight in the PCIe fabric and an NP or CPL TLP is transmitted immediately afterward. These examples should ensure detection in all cases and not miss any reordering. A drawback of late detection is that a NP read that was re-ordered ahead of posted can return stale data which is not desirable and the software consuming that stale data needs to have mechanism to rollback to previous good state after the IDE error is detected.

Some examples deal with the immediate detection of reordered NP or CPL TLPs. These examples should ensure that if an NP or CPL TLP is received before the IDE_SYNC that preceded it, then the receiver immediately detects an error. These examples redefine the rules related to sending IDE_SYNC message and receiving IDE_SYNC message. These examples should also ensure detection in all cases and do not miss any reordering.

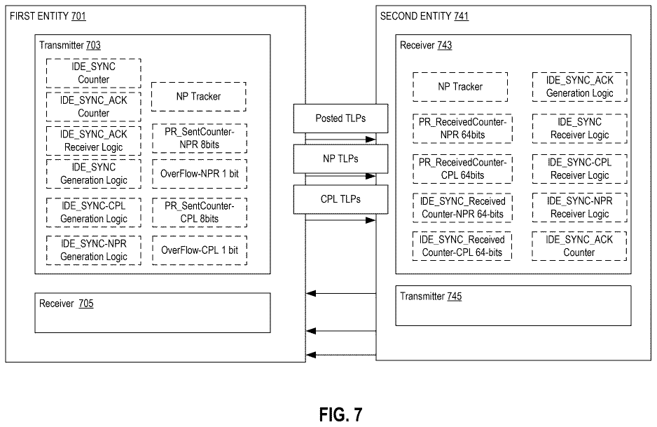

FIG. 7 illustrates examples of PCIe entities (e.g., devices such as endpoints and roots) that support IDE. The first entity 701 and second entity 741 are a root and endpoint respectively in some examples, but may be other entities (e.g., one or more may be a switch, etc.) in some examples.

As shown, each entity includes a transmitter portion (shown as transmitter 703 and transmitter 745) and a receiver portion (shown as receiver 705 and receiver 743). Within a transmitter portion, there may be several different components. In some examples, there are one or more counters such as one or more of an IDE_SYNC counter to be incremented when an IDE_SYNC is sent, an IDE_SYNC_ACK counter to be incremented when an IDE_SYNC_ACK (IDE_SYNC acknowledged) message is received, an IDE_SYN_ACK receiver logic to receive IDE_SYN_ACK messages from a receiver of a different device (e.g., receiver 743), IDE_SYNC generation logic to generate IDE_SYNC messages, IDE_SYNC-CPL generation logic to generate IDE_SYNC-CPL messages (note that a IDE_SYNC-CPL message is a posted request and implicitly causes an increment of one or more counters when sent and received), IDE_SYNC-NPR generation logic to generate IDE_SYNC-NPR messages (note that a IDE_SYNC-NPR message is a posted request and implicitly causes an increment of one or more counters when sent and received), a PR_SentCounter-NPR to maintain a count of Posted Requests Transmitted since the last Non-Posted Request or IDE Sync Message was Transmitted, a PR_SentCounter-CPL to maintain a count of Posted Requests Transmitted since the last Completion or IDE Sync Message was Transmitted, a mechanism to set an Overflow-NPR bit, a mechanism to set an Overflow-CPL bit, etc.

Within a receiver portion, there may be several different components. In some examples, there are one or more counters such as one or more of an IDE_SYNC_received counter-NPR to be incremented when an IDE_SYNC-NPR is received, an IDE_SYNC_received counter-CPL to be incremented when an IDE_SYNC-CPL is received, a PR_Received_Counter-NPR to count posted requests since the last Non-Posted Request was received, a PR_Received_Counter-CPL to count Posted Requests received since the last Completion was received, an IDE_SYNC_ACK counter to count IDE_SYNC_ACK messages, IDE_SYNC_ACK generation logic to generate an IDE_SYNC_ACK message, an IDE_SYNC receiver logic to handle the receiving of an IDE_SYNC message, an IDE_SYNC-CPL receiver logic to handle the receiving of an IDE_SYNC-CPL message, an IDE_SYNC-NPR receiver logic to handle the receiving of an IDE_SYNC-NPR message, etc.

An issue with the existing solutions is that when an NP or CPL TLP is sent after an IDE_SYNC with a count of 0, the switch can reorder this transaction, causing the reordering to be missed, as detailed above. However, when the count value is greater than 0, reordering can be detected when the next IDE_SYNC is received.

Some examples use different rules than those defined in the PCIe IDE specification. These different rules aim to ensure that NP TLPs account for whether an IDE_SYNC was sent ahead of them. Therefore, an NP TLP or CPL TLP transmitted immediately after an IDE_SYNC starts with a count of 1. To maintain the correct count of transmitted posts, the IDE_SYNC does not count itself.

In some examples, these rules are:
The transmitter counter is not incremented until the IDE_SYNC message is sent.
The transmitter counter is reset to 1 after sending the IDE_SYNC message.
When the receiver receives the IDE_SYNC message, it performs the ordering check before incrementing its counters.

An example of this approach with NP TLP is as follows: NP TLP (Posted Counter=1) , {IDE_SYNC (Posted counter=247), Posted TLP245,. . . ., Posted TLP1, Posted TLP0, IDE_SYNC (Posted counter=246)}, Posted TLP245,. . . ., Posted TLP1, Posted TLP0

If the fabric re-orders the NP then the IDE sync Posted counter will mismatch. IDE_SYNC (PR_Sent_Counter-NPR=247)—counter mismatch, Posted TLP245,. . . ., Posted TLP1, Posted TLP0, inserted NP TLP (Posted Counter=1) , IDE_SYNC (Posted counter=246), Posted TLP245,. . . ., Posted TLP1, Posted TLP0

After sending IDE_SYNC Posted counter is reset to 1. This is to count the IDE_SYNC itself. If a NP TLP is sent immediately after IDE sync, then it's sent with the Posted Count of 1 and after that the posted count is reset to 0. The next IDE_SYNC that is sent will be with the count of 246 or 247. If a NP TLP was sent previously count is 246, else it would be 247.

In some examples, an immediate detection method of reordered NP or CPL TLP is supported. In some examples, the PCIe rules are related to transmission of an IDE_SYNC message are modified. When the PR_Sent_Counter (NPR or CPL) reaches the maximum value of threshold (e.g., 254) an overflow bit in the transmitter is used to track the overflow and IDE_SYNC_X (where X is NPR/CPL) is transmitted just before sending the CPL or NP message if the Overflow-CPL/NPR is set.

The CPL or NP TLP following an IDE_SYNC_X message is special since the receiver uses it to decrement the IDE_SYNC_ACK_Counter-CPL/NPR. To differentiate this from the regular CPL/NP TLPs there are at least two options. A first option is to use the reserved bit in the TLP (e.g., R in FIG. 4) for the overflow bit to identify the TLP as a NP or CPL request that came after the overflow-NP/CPL is set. And in this case the PR_Sent_Counter in the IDE prefix equals PR_SentCounter-NPR/CPL for the NPR and CPL TLP respectively. A second option is to transmit the NP and CPL TLP with the PR_Sent_Counter value of 255 and in this case IDE_SYNC_NP/CPL message that occurs prior to NP/CPL carries the PR_Sent_Counter in the IDE prefix that equals PR_SentCounter-NPR/CPL. In some examples, for every IDE_SYNC_X message there is always a paired NP or CPL TLP with a PR_Sent_Counter=255.

Examples of rules that a transmitter and a receiver must follow are defined below. In some examples, the rules are defined for CPL TLP but are also applicable for NP TLP in some examples. New message types of IDE_SYNC_CPL and/or IDE_SYNC_NP are to be transmitted before NP or CPL when the overflow bit is set. An IDE_SYNC_X message is used for incrementing the IDE_SYNC_COUNTER_X in the receiver which is decremented when the corresponding CPL is received.

### Transmitter Rules

1. PR_Sent_Counter-CPL starts with an initial value=0 and is incremented whenever Posted TLP is sent out.
2. When PR_Sent_Counter-CPL equals a threshold (e.g., 254), the transmitter transmits IDE_SYNC message with PR_Sent_Count-CPL=threshold (e.g., 254), sets an overflow bit, and resets the PR_Sent_Counter-CPL to 0.
3. When a transmitter needs to transmit a CPL and if the overflow-CPL bit is 1, it has two options in some examples:
   a. Option1: It first transmits IDE_SYNC_CPL message with a PR_Sent_Count-CPL=PR_Sent_Counter-CPL. It then resets the PR_Sent_Counter-CPL and then transmits the CPL with PR_Sent_Counter=255 and clears the overflow bit and resets the PR_Sent_Counter-CPL to 0.
   b. Option2: It first transmits IDE_SYNC_CPL message and PR_Sent_Counter fields are ignored or not present in IDE_SYNC_CPL message, it then transmits the CPL with PR_Sent_Counter=PR_Sent_Count-CPL and also sets the overflow bit in the IDE prefix as shown in FIG. 6-63 above. And resets the PR_Sent_Counter-CPL to0.

### Receiver Rules

1. The receiver increments the PR_Received_Counter-CPL when it receives posted TLPs.
2. The receiver decrements the PR_Received_Counter-CPL with the PR_Sent_Counter value in CPL TLP (for CPL TLPs only if the PR_Sent_Counter is not 255), IDE_SYNC TLP and IDE_SYNC_CPL TLPs, if the result underflows it flags an Error.
3. The receiver increments IDE_SYNC_COUNTER-CPL when it receives IDE_SYNC_CPL and decrements it when it receives CPL (with PR_Sent_Counter=255) when the result underflows it flags an error.

Note that the detection may be performed by the IDE_SYNC receiver logic, IDE_SYNC-CPL receiver logic, and/or IDE_SYNC-NPR receiver logic depending on the example.

An example of this is detailed below. For example, a transmitter sends this sequence:
CPL TLP (Count=0) CPL TLP (Count=255) IDE_SYNC_CPL (count=254) Posted TLP (253) Posted TLP (0) IDE_SYNC(Count=254) Posted TLP (253) . . . Posted TLP (0) CPL TLP (Count=0) CPL TLP (Count=255) IDE_SYNC_CPL (Count=254) Posted TLP (253) Posted TLP (0) IDE_SYNC(Count=254) Posted TLP (253) . . . Posted TLP (0)

If the Switch reorders the CPL then it will be detected using the IDE_SYNC_Counter.
CPL TLP (Count=0) IDE_SYNC_CPL (count=254) Posted TLP (253) Posted TLP (0) IDE_SYNC(Count=254) Posted TLP (253) . . . Posted TLP (0) CPL TLP (Count=255) CPL TLP (Count=0) CPL TLP (Count=255) IDE_SYNC_CPL (Count=254) Posted TLP (253) Posted TLP (0) IDE_SYNC(Count=254) Posted TLP (253) . . . Posted TLP (0)

Note that the detection may be performed by the IDE_SYNC receiver logic, IDE_SYNC-CPL receiver logic, and/or IDE_SYNC-NPR receiver logic depending on the example.

In some examples, an immediate detection method of reordered NP or CPL TLP comes at the cost of increased posted TLP traffic. In these examples, the transmitter transmits an IDE_SYNC-X message where X=NPR or CPL TLP (e.g., generated by IDE_SYNC-CPL generation logic or IDE_SYNC-NPR generation logic) before transmitting the CPL and NP TLP, the IDE_SYNC message acts a fence for NP TLPs and CPL TLPs.

The receiver counts the number of IDE_SYNC-X messages received (e.g., by the IDE_SYNC-NPR receiver logic or IDE_SYNC-CPL receiver logic updating the IDE_SYNC_Received counter-NPR or IDE_SYNC_Received counter-CPL) and increments the IDE_SYNC Counter on receiving IDE_SYNC_X and decrements the counter on receiving corresponding NPR or CPL TLP.

If the IDE_SYNC Counter underflows it implies that NPR or CPL TLP was reordered ahead of its IDE_SYNC-X message and therefore re-ordering is immediately detected.

Rules for these examples include:
In some examples, the PR_Received_Counter-NPR and PR_Received_Counter-CPL are repurposed as IDE_Sync_Received_Counter-NPR and IDE_Sync_Received_Counter-CPL, respectively.
Whenever the transmitter sends an NPR, it must first send an IDE_Sync-NPR message. The PR_Sent_Counter value in the NPR TLP is unused.
Whenever the transmitter sends a CPL, it must first send an IDE_Sync-CPL message. The PR_Sent_Counter value in the CPL TLP is unused.
Whenever the receiver receives IDE_Sync-NPR, it increments the respective counter.
Whenever the receiver receives NPR, it decrements the respective counter=Underflow triggers an error.
Whenever the receiver receives IDE_Sync-CPL, it increments the respective counter.
Whenever the receiver receives CPL, it decrements the respective counter. Underflow triggers an error.

In some examples, an immediate detection method of reordered NP or CPL TLP uses blocking of NP and CPL TLPs at the transmitter. In these examples, NP and CPL TLPs are blocked until all previous IDE_SYNCs ahead of them are drained. The receiver sends an IDE_SYNC_ACK to acknowledge the draining of IDE_SYNCs. Given that traffic over IDE would typically be a mix of posted and non-posted requests, blocking non-posted requests and completion should not be a concern.

The maximum number of IDE_SYNCs in flight in the PCIe fabric is the difference between the IDE_SYNC_COUNTER and the IDE_SYNC_ACK_COUNTER as the IDE_SYNC_COUNTER is incremented whenever an IDE_SYNC is sent and the IDE_SYNC_ACK_COUNTER is incremented whenever an IDE_SYNC_ACK is received.

When a new NP request or completion arrives a snapshot of the difference (IDE_SYNC_COUNTER-IDE_SYNC_ACK_COUNTER) is taken and stored in a tracker (e.g., maintained by IDE_SYNC_ACK receiver logic). NP or CPL TLPs are allowed to be transmitted only after all in-flight IDE_SYNCs ahead of them are drained. This difference is decremented for each NP request or completion tracked each time an IDE_SYNC_ACK is received. When the difference reaches 0, it implies all IDE_SYNCs ahead of the NP are drained, and the NP request is ready to be sent.

In some examples, to optimize the area of the tracker, the size of the difference (IDE_SYNC_COUNTER-IDE_SYNC_ACK_COUNTER) stored in the NP or CPL tracker can be reduced to a smaller 4- or 8-bit number instead of 64 bits. When 8 bits are used for storing the difference in the NP tracker, if the difference is greater than or equal to 255, NP or CPL TLPs are blocked until the difference becomes smaller.

In some examples, NP requests that are tracked have three states:
1. BLOCKED: When the counter difference is >=255. In this case, the counter difference is updated on the next IDE_SYNC as soon as it becomes <255.
2. PREPARE: When the counter difference is <255. The counter difference is the actual value (<255), and it is decremented on IDE_SYNC_ACK.
3. READY: When the counter difference is 0. The counter difference is 0, and the request can be sent out.

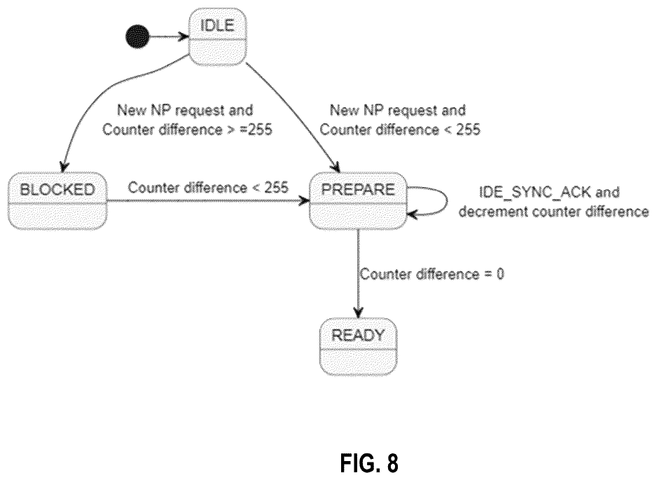

FIG. 8 illustrates examples of a state machine for the NP tracker.

As noted in the PCIe specification, the ordering rules define constraints on TLP/TLP ordering, but do not provide mechanisms to detect improper reordering. With IDE, counters are used to enable the ultimate Receiver to detect improper reordering of non-unordered input/output (non-UIO) TLPs while allowing permitted reordering. These counters and associated mechanisms, including error checks, do not apply to UIO TLPs.

In some examples, separate sets of these counters must be operated for each IDE stream, and operated according to the following rules:
For the Transmitter, two 8-bit counters are maintained: a count of Posted Requests Transmitted since the last Non-Posted Request or IDE Sync Message was Transmitted, called PR_Sent_Counter-NPR, and a count of Posted Requests Transmitted since the last Completion or IDE Sync Message was Transmitted, called PR_Sent_Counter-CPL. In some examples, the transmitter must additionally maintain 1 bit called Overflow-NPR and 1 bit called Overflow-CPL.
   Upon entry to the Secure state, both counters and the overflow bits must be initialized to 0.
   Both counters must be incremented for each Posted Request IDE TLP Transmitted associated with the IDE Stream.
   When a Non-Posted Request associated with the IDE Stream is Transmitted: the PR_Sent_Counter-NPR value must be used in the PR_Sent_Counter field of the IDE Prefix (NFM)/OHC-C (FM) for the Non-Posted Request, the Overflow bit of the IDE Prefix must be set according to Overflow-NPR, and then PR_Sent_Counter-NPR and Overflow-NPR must be reset to zero.
      If Overflow-NPR is set, then an IDE Sync NPR Message must be sent prior to sending the Non-Posted Request.
   When a Completion associated with the IDE Stream is Transmitted: the PR_Sent_Counter-CPL value must be used in the PR_Sent_Counter field of the IDE Prefix (NFM)/OHC-C (FM) for the Completion, the Overflow bit of the IDE Prefix must be set according to Overflow-CPL, and then PR_Sent_Counter-CPL and Overflow-CPL must be reset to zero.
      If Overflow-CPL is set, then an IDE Sync NPR Message must be sent prior to sending the Completion.
   When PR_Sent_Counter-NPR or PR_Sent_Counter-CPL reaches 245, an IDE Sync Message must be transmitted to the Partner Port as an IDE TLP.
      It is permitted to Transmit an IDE Sync Message at other times.
   Every time an IDE Sync Message is Transmitted to the Partner Port, both the PR_Sent_Counter-NPR and PR_Sent_Counter-CPL must be incremented prior to forming the IDE Sync Message, and then both the PR_Sent_Counter-NPR and PR_Sent_Counter-CPL must be reset to zero. Overflow-NPR and Overflow-CPL must also be set to one.
For the Receiver, four 64-bit counters are to be maintained: a count of Posted Requests received since the last Non-Posted Request was received, called PR_Received_Counter-NPR and a count of Posted Requests received since the last Completion was received, called PR_Received_Counter-CPL, a count of IDE Sync Messages received since the last Non-Posted Request was received, called IDE_Sync_Received_Counter-NPR, and a count of IDE Sync Messages received since the last Completion was received, called IDE_Sync_Received_Counter-CPL.
   Upon entry to the Secure state, all four counters must be initialized to zero.
   PR_Received_Counter-NPR and PR_Received_Counter-CPL must be incremented for each Posted Request IDE TLP received associated with the IDE Stream.
   Whenever an IDE Sync NPR Message is received, IDE_Sync_Received_Counter-NPR must be incremented.
   Whenever an IDE Sync CPL Message is received, IDE_Sync_Received_Counter-CPL must be incremented.
   When a Non-Posted Request associated with the IDE Stream is received, the PR_Sent_Counter value must be subtracted from PR_Received_Counter-NPR, and the PR_Received_Counter-NPR updated with the result. If this subtraction underflows, this is an error-see rules related to error handling below.
      Additionally, if the Overflow bit carried in the IDE prefix (NFM)/OHC-C (FM) is set, IDE_Sync_Received_Counter-NPR must be decremented. If this subtraction underflows, this is an error—see rules related to error handling below.
   When a Completion associated with the IDE Stream is received, the PR_Sent_Counter value must be subtracted from PR_Received_Counter-CPL, and the PR_Received_Counter-CPL updated with the result. If this subtraction underflows, this is an error-see rules related to error handling below.
      Additionally, if the Overflow bit carried in the IDE prefix (NFM)/OHC-C (FM) is set, IDE_Sync_Received_Counter-CPL must be decremented. If this subtraction underflows, this is an error-see rules related to error handling below.
   When an IDE Sync Message associated with the IDE Stream is received:
      the PR_Sent_Counter-NPR value carried in the IDE Stream Sync Message must be subtracted from the PR_Received_Counter-NPR, and the PR_Received_Counter-NPR updated with the result,
      the PR_Sent_Counter-CPL value carried in the IDE Stream Sync Message must be subtracted from the PR_Received_Counter-CPL, and the PR_Received_Counter-CPL updated with the result.

In some examples, the transmitter maintains 1 bit called Overflow-NPR and 1 bit called Overflow-CPL. In some examples, the overflow bit is not required in the IDE prefix. In some examples, counters must be operated for each IDE Stream, and operated according to the following rules:
For the Transmitter, two 8-bit counters must be maintained: a count of Posted Requests Transmitted since the last Non-Posted Request or IDE Sync Message was Transmitted, called PR_Sent_Counter-NPR, and a count of Posted Requests Transmitted since the last Completion or IDE Sync Message was Transmitted, called PR_Sent_Counter-CPL. The transmitter must additionally maintain 1 bit called Overflow-NPR and 1 bit called Overflow-CPL.
   Upon entry to the Secure state, both counters and the overflow bits must be initialized to 0.
   Both counters must be incremented for each Posted Request IDE TLP Transmitted associated with the IDE Stream.
   When a Non-Posted Request associated with the IDE Stream is Transmitted:
      If Overflow-NPR is clear, the PR_Sent_Counter-NPR value must be used in the PR_Sent_Counter field of the IDE Prefix (NFM)/OHC-C (FM) for the Non-Posted Request, and then PR_Sent_Counter-NPR must be reset to zero.
      If Overflow-NPR is set, the Transmitter must first send an IDE Sync NPR Message with the PR_Sent_Counter field of the IDE Prefix (NFM)/OHC-C (FM) set to PR_Sent_Counter-NPR. Note that PR_Sent_Counter-NPR and PR_Sent_Counter-CPL must first be incremented before forming the IDE Sync NPR Message. The Transmitter must then send the Non-Posted Request with the PR_Sent_Counter field of the IDE Prefix (NFM)/OHC-C (FM) set to 255, and PR_Sent_Counter-NPR and Overflow-NPR must be reset to 0.
   When a Completion associated with the IDE Stream is Transmitted:
      If Overflow-CPL is clear, the PR_Sent_Counter-CPL value must be used in the PR_Sent_Counter field of the IDE Prefix (NFM)/OHC-C (FM) for the Completion, and then PR_Sent_Counter-CPL must be reset to zero.
      If Overflow-CPL is set, the Transmitter must first send an IDE Sync CPL Message with the PR_Sent_Counter field of the IDE Prefix (NFM)/OHC-C (FM) set to PR_Sent_Counter-CPL. Note that PR_Sent_Counter-NPR and PR_Sent_Counter-CPL must first be incremented before forming the IDE Sync CPL Message. The Transmitter must then send the Completion with the PR_Sent_Counter field of the IDE Prefix (NFM)/OHC-C (FM) set to 255, and PR_Sent_Counter-CPL and Overflow-CPL must be reset to 0.
   When PR_Sent_Counter-NPR or PR_Sent_Counter-CPL reaches 245, an IDE Sync Message must be transmitted to the Partner Port as an IDE TLP.
      It is permitted to Transmit an IDE Sync Message at other times.
   Every time an IDE Sync Message is Transmitted to the Partner Port, both the PR_Sent_Counter-NPR and PR_Sent_Counter-CPL must be incremented prior to forming the IDE Sync Message, and then both the PR_Sent_Counter-NPR and PR_Sent_Counter-CPL must be reset to zero. Overflow-NPR and Overflow-CPL must also be set to one.
For the Receiver, four 64-bit counters must be maintained: a count of Posted Requests received since the last Non-Posted Request was received, called PR_Received_Counter-NPR and a count of Posted Requests received since the last Completion was received, called PR_Received_Counter-CPL, a count of IDE Sync Messages received since the last Non-Posted Request was received, called IDE_Sync_Received_Counter-NPR, and a count of IDE Sync Messages received since the last Completion was received, called IDE_Sync_Received_Counter-CPL.
   Upon entry to the Secure state, all four counters must be initialized to zero.
   PR_Received_Counter-NPR and PR_Received_Counter-CPL must be incremented for each Posted Request IDE TLP received associated with the IDE Stream.
   Whenever an IDE Sync NPR Message is received, the PR_Sent_Counter value carried in the IDE prefix (NFM)/OHC-C (FM) must be subtracted from the PR_Received_Counter-NPR, and the PR_Received_Counter-NPR updated with the result. If this subtraction underflows, this is an error-see rules related to error handling below. Additionally, IDE_Sync_Received_Counter-NPR must be incremented.
   Whenever an IDE Sync CPL Message is received, the PR_Sent_Counter value carried in the IDE prefix (NFM)/OHC-C (FM) must be subtracted from the PR_Received_Counter-CPL, and the PR_Received_Counter-CPL updated with the result. If this subtraction underflows, this is an error-see rules related to error handling below. Additionally, IDE_Sync_Received_Counter-CPL must be incremented.
   When a Non-Posted Request associated with the IDE Stream is received:
      If the PR_Sent_Counter value carried in the IDE prefix (NFM)/OHC-C (FM) is not equal to 255, then the PR_Sent_Counter value must be subtracted from PR_Received_Counter-NPR, and the PR_Received_Counter-NPR updated with the result. If this subtraction underflows, this is an error-see rules related to error handling below.
      If the PR_Sent_Counter value carried in the IDE prefix (NFM)/OHC-C (FM) is equal to 255, IDE_Sync_Received_Counter-NPR must be decremented. If this subtraction underflows, this is an error-see rules related to error handling below.
   When a Completion associated with the IDE Stream is received:
      If the PR_Sent_Counter value carried in the IDE prefix (NFM)/OHC-C (FM) is not equal to 255, then the PR_Sent_Counter value must be subtracted from PR_Received_Counter-CPL, and the PR_Received_Counter-CPL updated with the result. If this subtraction underflows, this is an error-see rules related to error handling below.
      If the PR_Sent_Counter value carried in the IDE prefix (NFM)/OHC-C (FM) is equal to 255, IDE_Sync_Received_Counter-CPL must be decremented. If this subtraction underflows, this is an error-see rules related to error handling below.
   When an IDE Sync Message associated with the IDE Stream is received:
      the PR_Sent_Counter-NPR value carried in the IDE Stream Sync Message must be subtracted from the PR_Received_Counter-NPR, and the PR_Received_Counter-NPR updated with the result,
      the PR_Sent_Counter-CPL value carried in the IDE Stream Sync Message must be subtracted from the PR_Received_Counter-CPL, and the PR_Received_Counter-CPL updated with the result.

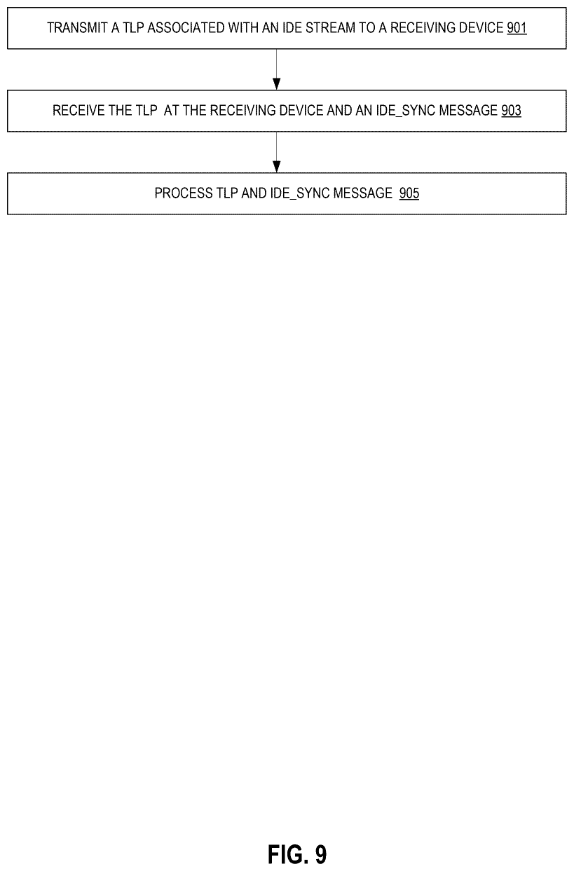

FIG. 9 illustrates examples of a method to be performed by a transmitter and receiver. The transmitter transmits one or more TLPs (which may be associated with posted, non-posted, or completion, SYNC, etc.) as a part of an IDE stream to a receiving device at 901. The transmission may can an update to one or more counters. IDE_SYNC messages may follow one or more of the above examples (e.g., with respect to number). The TLP may also use an updated prefix (e.g., use the R bit).

The one or more TLPs are received at the receiving device at 903. The receiving may can an update to one or more counters and/or cause a response to be sent such as an IDE_SYNC_ACK message. In some examples, an IDE_SYNC message is received. This could be received before or after the one or more TLPs.

The one or more TLPs and received IDE_SYNC message are processed at 905. Examples of processing such as detecting ordering, updating counters, updating trackers (e.g., overflow bits), etc. are detailed above. The processing is described as adhering to one or more rules in some examples detailed above. For example, an NP or CLP TLP may be blocked, resent, re-ordered, etc.

### Example Architectures

Detailed below are descriptions of example computer architectures. Other system designs and configurations known in the arts for laptop, desktop, and handheld personal computers (PC)s, personal digital assistants, engineering workstations, servers, disaggregated servers, network devices, network hubs, switches, routers, embedded processors, digital signal processors (DSPs), graphics devices, video game devices, set-top boxes, micro controllers, cell phones, portable media players, hand-held devices, and various other electronic devices, are also suitable. In general, a variety of systems or electronic devices capable of incorporating a processor and/or other execution logic as disclosed herein are generally suitable.

### Example Systems

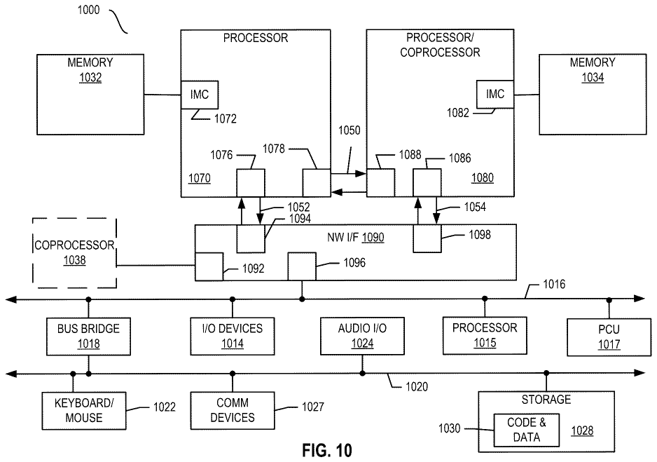

FIG. 10 illustrates an example computing system. Multiprocessor system 1000 is an interfaced system and includes a plurality of processors or cores including a first processor 1070 and a second processor 1080 coupled via an interface 1050 such as a point-to-point (P-P) interconnect, a fabric, and/or bus. In some examples, the first processor 1070 and the second processor 1080 are homogeneous. In some examples, first processor 1070 and the second processor 1080 are heterogenous. Though the example multiprocessor system 1000 is shown to have two processors, the system may have three or more processors, or may be a single processor system. In some examples, the computing system is a system on a chip (SoC).

Processors 1070 and 1080 are shown including integrated memory controller (IMC) circuitry 1072 and 1082, respectively. Processor 1070 also includes interface circuits 1076 and 1078; similarly, second processor 1080 includes interface circuits 1086 and 1088. Processors 1070, 1080 may exchange information via the interface 1050 using interface circuits 1078, 1088. IMCs 1072 and 1082 couple the processors 1070, 1080 to respective memories, namely a memory 1032 and a memory 1034, which may be portions of main memory locally attached to the respective processors.

Processors 1070, 1080 may each exchange information with a network interface (NW I/F) 1090 via individual interfaces 1052, 1054 using interface circuits 1076, 1094, 1086, 1098. The network interface 1090 (e.g., one or more of an interconnect, bus, and/or fabric, and in some examples is a chipset) may optionally exchange information with a co-processor 1038 via an interface circuit 1092. In some examples, the co-processor 1038 is a special-purpose processor, such as, for example, a high-throughput processor, a network or communication processor, a compression engine, a graphics processor, a general purpose graphics processing unit (GPGPU), a neural-network processing unit (NPU), an embedded processor, a security processor, a cryptographic accelerator, a matrix accelerator, an in-memory analytics accelerator,, a data streaming accelerator, data graph operations, or the like.

A shared cache (not shown) may be included in either processor 1070, 1080 or outside of both processors, yet connected with the processors via an interface such as P-P interconnect, such that either or both processors'local cache information may be stored in the shared cache if a processor is placed into a low power mode.

Network interface 1090 may be coupled to a first interface 1016 via interface circuit 1096. In some examples, first interface 1016 may be an interface such as a Peripheral Component Interconnect (PCI) interconnect, a PCI Express interconnect or another I/O interconnect. In some examples, first interface 1016 is coupled to a power control unit (PCU) 1017, which may include circuitry, software, and/or firmware to perform power management operations with regard to the processors 1070, 1080 and/or co-processor 1038. PCU 1017 provides control information to a voltage regulator (not shown) to cause the voltage regulator to generate the appropriate regulated voltage. PCU 1017 also provides control information to control the operating voltage generated. In various examples, PCU 1017 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 1017 is illustrated as being present as logic separate from the processor 1070 and/or processor 1080. In other cases, PCU 1017 may execute on a given one or more of cores (not shown) of processor 1070 or 1080. In some cases, PCU 1017 may be implemented as a microcontroller (dedicated or general-purpose) or other control logic configured to execute its own dedicated power management code, sometimes referred to as P-code. In yet other examples, power management operations to be performed by PCU 1017 may be implemented externally to a processor, such as by way of a separate power management integrated circuit (PMIC) or another component external to the processor. In yet other examples, power management operations to be performed by PCU 1017 may be implemented within BIOS or other system software.

Various I/O devices 1014 may be coupled to first interface 1016, along with a bus bridge 1018 which couples first interface 1016 to a second interface 1020. In some examples, one or more additional processor(s) 1015, such as co-processors, high throughput many integrated core (MIC) processors, GPGPUs, accelerators (such as graphics accelerators or digital signal processing (DSP) units), field programmable gate arrays (FPGAs), or any other processor, are coupled to first interface 1016. In some examples, second interface 1020 may be a low pin count (LPC) interface. Various devices may be coupled to second interface 1020 including, for example, a keyboard and/or mouse 1022, communication devices 1027 and storage circuitry 1028. Storage circuitry 1028 may be one or more non-transitory machine-readable storage media as described below, such as a disk drive or other mass storage device which may include instructions/code and data 1030 and may implement the storage ISAB03 in some examples. Further, an audio I/O 1024 may be coupled to second interface 1020. Note that other architectures than the point-to-point architecture described above are possible. For example, instead of the point-to-point architecture, a system such as multiprocessor system 1000 may implement a multi-drop interface or other such architecture.

### Example Core Architectures, Processors, and Computer Architectures

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a co-processor including one or more special purpose cores intended primarily for graphics and/or scientific (throughput) computing. Such different processors lead to different computer system architectures, which may include: 1) the co-processor on a separate chip from the CPU; 2) the co-processor on a separate die in the same package as a CPU; 3) the co-processor on the same die as a CPU (in which case, such a co-processor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described co-processor, and additional functionality. Example core architectures are described next, followed by descriptions of example processors and computer architectures.

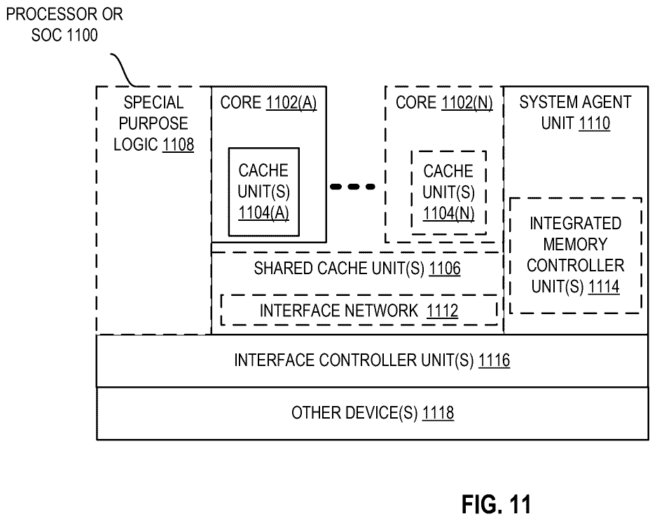

FIG. 11 illustrates a block diagram of an example processor and/or SoC 1100 that may have one or more cores and an integrated memory controller. The solid lined boxes illustrate a processor and/or SoC 1100 with a single core 1102(A), system agent unit circuitry 1110, and a set of one or more interface controller unit(s) circuitry 1116, while the optional addition of the dashed lined boxes illustrates an alternative processor and/or SoC 1100 with multiple cores 1102(A)-(N), a set of one or more integrated memory controller unit(s) circuitry 1114 in the system agent unit circuitry 1110, and special purpose logic 1108, as well as a set of one or more interface controller unit(s) circuitry 1116. Note that the processor and/or SoC 1100 may be one of the processors 1070 or 1080, or co-processor 1038 or 1015 of FIG. 10.

Thus, different implementations of the processor and/or SoC 1100 may include: 1) a CPU with the special purpose logic 1108 being a high-throughput processor, a network or communication processor, a compression engine, a graphics processor, a general purpose graphics processing unit (GPGPU), a neural-network processing unit (NPU), an embedded processor, a security processor, a matrix accelerator, an in-memory analytics accelerator, a compression accelerator, a data streaming accelerator, data graph operations, or the like(which may include one or more cores, not shown), and the cores 1102(A)-(N) being one or more general purpose cores (e.g., general purpose in-order cores, general purpose out-of-order cores, or a combination of the two); 2) a co-processor with the cores 1102(A)-(N) being a large number of special purpose cores intended primarily for graphics and/or scientific (throughput); and 3) a co-processor with the cores 1102(A)-(N) being a large number of general purpose in-order cores. Thus, the processor and/or SoC 1100 may be a general-purpose processor, co-processor or special-purpose processor, such as, for example, a network or communication processor, compression engine, graphics processor, GPGPU (general purpose graphics processing unit), a high throughput many integrated core (MIC) co-processor (including 30 or more cores), embedded processor, or the like. The processor may be implemented on one or more chips. The processor and/or SoC 1100 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 1104(A)-(N) within the cores 1102(A)-(N), a set of one or more shared cache unit(s) circuitry 1106, and external memory (not shown) coupled to the set of integrated memory controller unit(s) circuitry 1114. The set of one or more shared cache unit(s) circuitry 1106 may include one or more mid-level caches, such as level 2 (L2), level 3 (L3), level 4 (L4), or other levels of cache, such as a last level cache (LLC), and/or combinations thereof. While in some examples interface network circuitry 1112 (e.g., a ring interconnect) interfaces the special purpose logic 1108 (e.g., integrated graphics logic), the set of shared cache unit(s) circuitry 1106, and the system agent unit circuitry 1110, alternative examples use any number of well-known techniques for interfacing such units. In some examples, coherency is maintained between one or more of the shared cache unit(s) circuitry 1106 and cores 1102(A)-(N). In some examples, interface controller unit(s) circuitry 1116 couple the cores 1102(A)-(N) to one or more other devices 1118 such as one or more I/O devices, storage, one or more communication devices (e.g., wireless networking, wired networking, etc.), etc.

In some examples, one or more of the cores 1102(A)-(N) are capable of multi-threading. The system agent unit circuitry 1110 includes those components coordinating and operating cores 1102(A)-(N). The system agent unit circuitry 1110 may include, for example, power control unit (PCU) circuitry and/or display unit circuitry (not shown). The PCU may be or may include logic and components needed for regulating the power state of the cores 1102(A)-(N) and/or the special purpose logic 1108 (e.g., integrated graphics logic). The display unit circuitry is for driving one or more externally connected displays.

The cores 1102(A)-(N) may be homogenous in terms of instruction set architecture (ISA). Alternatively, the cores 1102(A)-(N) may be heterogeneous in terms of ISA; that is, a subset of the cores 1102(A)-(N) may be capable of executing an ISA, while other cores may be capable of executing only a subset of that ISA or another ISA.

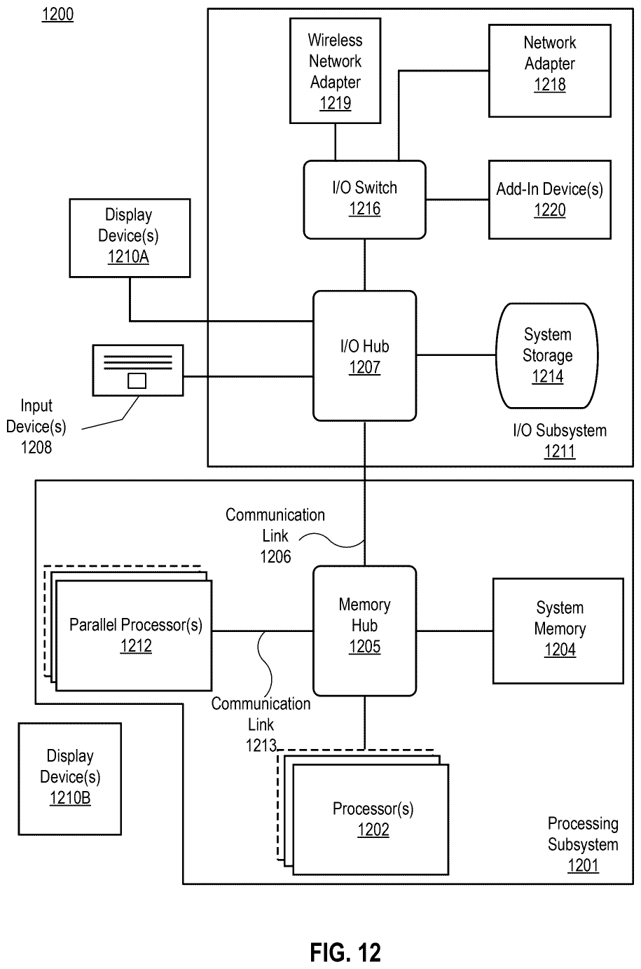

FIG. 12 is a block diagram illustrating a computing system 1200 configured to implement one or more aspects of the examples described herein. The computing system 1200 includes a processing subsystem 1201 having one or more processor(s) 1202 and a system memory 1204 communicating via an interconnection path that may include a memory hub 1205. The memory hub 1205 may be a separate component within a chipset component or may be integrated within the one or more processor(s) 1202. The memory hub 1205 couples with an I/O subsystem 1211 via a communication link 1206. The I/O subsystem 1211 includes an I/O hub 1207 that can enable the computing system 1200 to receive input from one or more input device(s) 1208. Additionally, the I/O hub 1207 can enable a display controller, which may be included in the one or more processor(s) 1202, to provide outputs to one or more display device(s) 1210A. In some examples the one or more display device(s) 1210A coupled with the I/O hub 1207 can include a local, internal, or embedded display device.

The processing subsystem 1201, for example, includes one or more parallel processor(s) 1212 coupled to memory hub 1205 via a bus or communication link 1213. The communication link 1213 may be one of any number of standards-based communication link technologies or protocols, such as, but not limited to PCI Express, or may be a vendor specific communications interface or communications fabric. The one or more parallel processor(s) 1212 may form a computationally focused parallel or vector processing system that can include a large number of processing cores and/or processing clusters, such as a many integrated core (MIC) processor. For example, the one or more parallel processor(s) 1212 form a graphics processing subsystem that can output pixels to one of the one or more display device(s) 1210A coupled via the I/O hub 1207. The one or more parallel processor(s) 1212 can also include a display controller and display interface (not shown) to enable a direct connection to one or more display device(s) 1210B.

Within the I/O subsystem 1211, a system storage unit 1214 can connect to the I/O hub 1207 to provide a storage mechanism for the computing system 1200. An I/O switch 1216 can be used to provide an interface mechanism to enable connections between the I/O hub 1207 and other components, such as a network adapter 1218 and/or wireless network adapter 1219 that may be integrated into the platform, and various other devices that can be added via one or more add-in device(s) 1220. The add-in device(s) 1220 may also include, for example, one or more external graphics processor devices, graphics cards, and/or compute accelerators. The network adapter 1218 can be an Ethernet adapter or another wired network adapter. The wireless network adapter 1219 can include one or more of a Wi-Fi, Bluetooth, near field communication (NFC), or other network device that includes one or more wireless radios.

The computing system 1200 can include other components not explicitly shown, including USB or other port connections, optical storage drives, video capture devices, and the like, which may also be connected to the I/O hub 1207. Communication paths interconnecting the various components in FIG. 12 may be implemented using any suitable protocols, such as PCI (Peripheral Component Interconnect) based protocols (e.g., PCI-Express), or any other bus or point-to-point communication interfaces and/or protocol(s), such as the NVLink high-speed interconnect, Compute Express Link™ (CXL™) (e.g., CXL.mem), Infinity Fabric (IF), Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Intel QuickPath Interconnect (QPI), Intel Ultra Path Interconnect (UPI), Intel On-Chip System Fabric (IOSF), Omnipath, HyperTransport, Advanced Microcontroller Bus Architecture (AMBA) interconnect, OpenCAPI, Gen-Z, Cache Coherent Interconnect for Accelerators (CCIX), 3GPP Long Term Evolution (LTE) (4G), 3GPP 5G, and variations thereof, or wired or wireless interconnect protocols known in the art. In some examples, data can be copied or stored to virtualized storage nodes using a protocol such as non-volatile memory express (NVMe) over Fabrics (NVMe-oF) or NVMe.

The one or more parallel processor(s) 1212 may incorporate circuitry optimized for graphics and video processing, including, for example, video output circuitry, and constitutes a graphics processing unit (GPU). Alternatively or additionally, the one or more parallel processor(s) 1212 can incorporate circuitry optimized for general purpose processing, while preserving the underlying computational architecture, described in greater detail herein. Components of the computing system 1200 may be integrated with one or more other system elements on a single integrated circuit. For example, the one or more parallel processor(s) 1212, memory hub 1205, processor(s) 1202, and I/O hub 1207 can be integrated into a system on chip (SoC) integrated circuit. Alternatively, the components of the computing system 1200 can be integrated into a single package to form a system in package (SIP) configuration. In some examples at least a portion of the components of the computing system 1200 can be integrated into a multi-chip module (MCM), which can be interconnected with other multi-chip modules into a modular computing system.

It will be appreciated that the computing system 1200 shown herein is illustrative and that variations and modifications are possible. The connection topology, including the number and arrangement of bridges, the number of processor(s) 1202, and the number of parallel processor(s) 1212, may be modified as desired. For instance, system memory 1204 can be connected to the processor(s) 1202 directly rather than through a bridge, while other devices communicate with system memory 1204 via the memory hub 1205 and the processor(s) 1202. In other alternative topologies, the parallel processor(s) 1212 are connected to the I/O hub 1207 or directly to one of the one or more processor(s) 1202, rather than to the memory hub 1205. In other examples, the I/O hub 1207 and memory hub 1205 may be integrated into a single chip. It is also possible that two or more sets of processor(s) 1202 are attached via multiple sockets, which can couple with two or more instances of the parallel processor(s) 1212.

Some of the particular components shown herein are optional and may not be included in all implementations of the computing system 1200. For example, any number of add-in cards or peripherals may be supported, or some components may be eliminated. Furthermore, some architectures may use different terminology for components similar to those illustrated in FIG. 12. For example, the memory hub 1205 may be referred to as a Northbridge in some architectures, while the I/O hub 1207 may be referred to as a Southbridge.

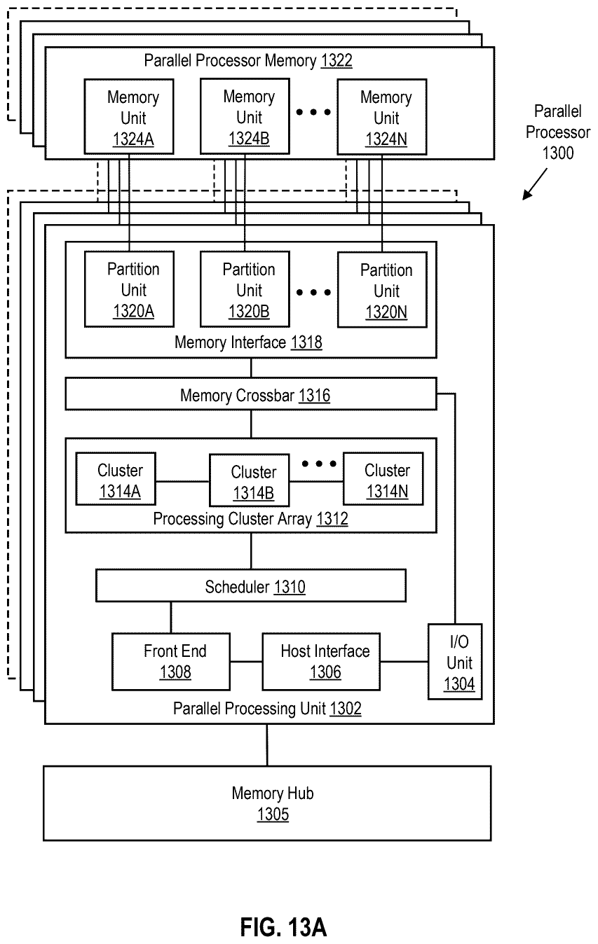

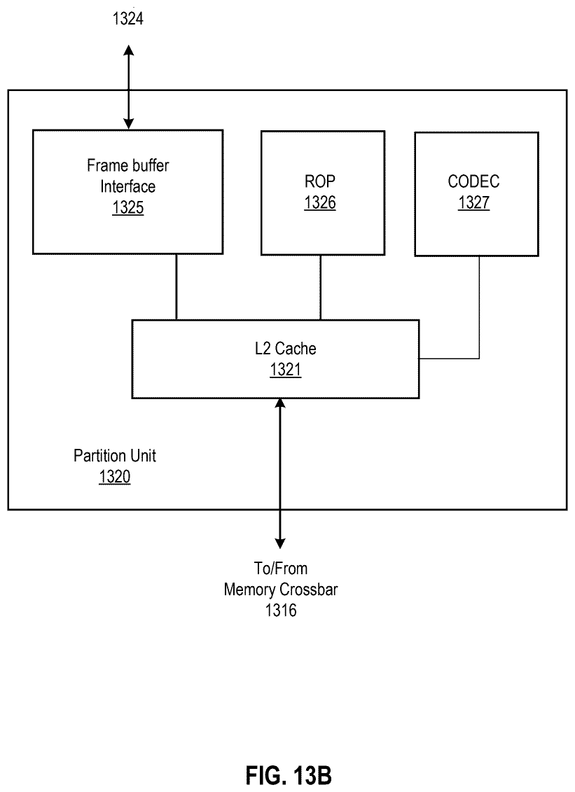

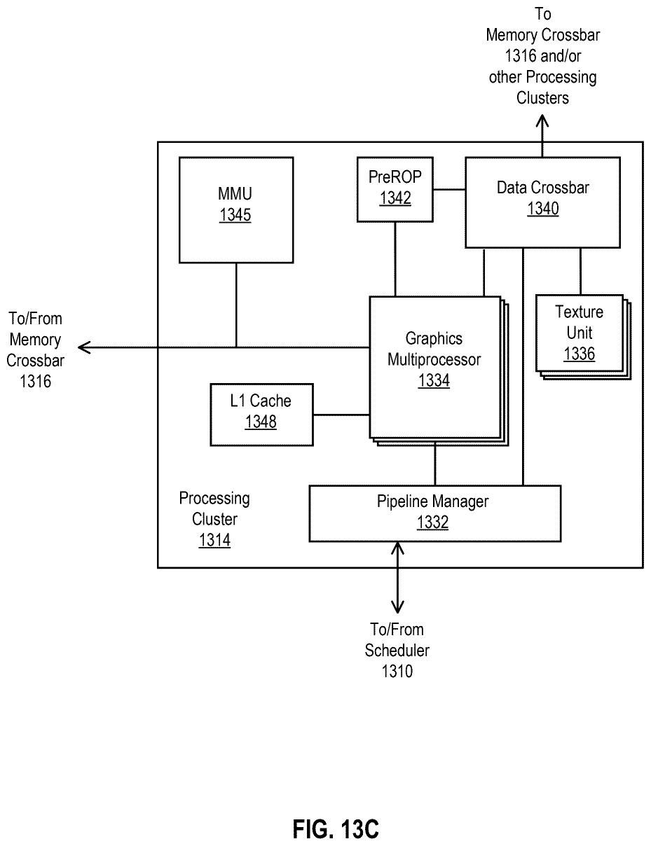

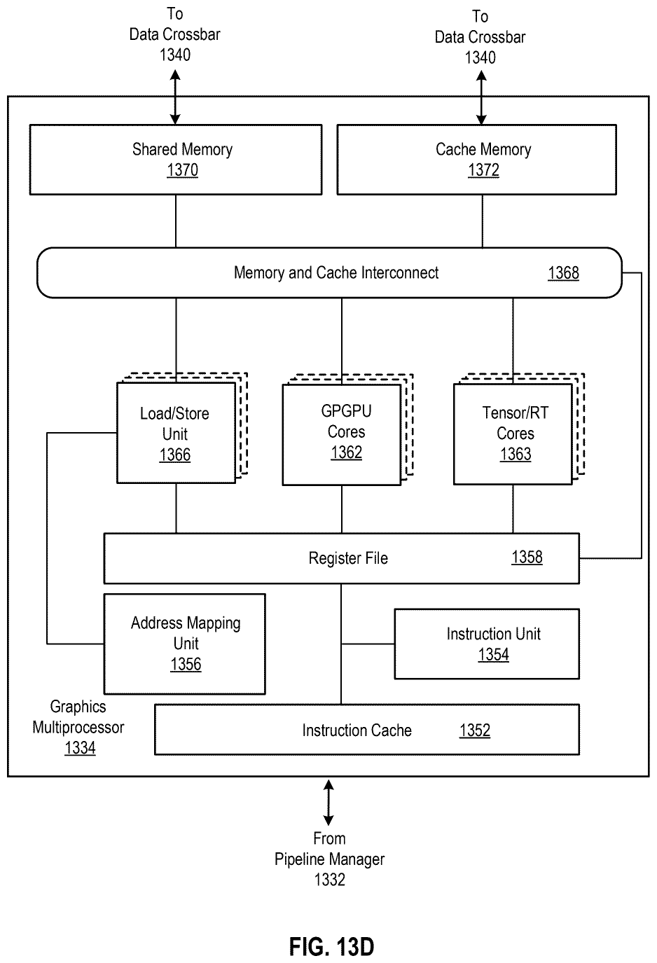

FIG. 13A illustrates examples of a parallel processor 1300. The parallel processor 1300 may be a GPU, GPGPU or the like as described herein. The various components of the parallel processor 1300 may be implemented using one or more integrated circuit devices, such as programmable processors, application specific integrated circuits (ASICs), or field programmable gate arrays (FPGA). The parallel processor 1300 may be one or more of the parallel processor(s) 1212 shown in FIG. 12.

The parallel processor 1300 includes a parallel processing unit 1302. The parallel processing unit includes an I/O unit 1304 that enables communication with other devices, including other instances of the parallel processing unit 1302. The I/O unit 1304 may be directly connected to other devices. For instance, the I/O unit 1304 connects with other devices via the use of a hub or switch interface, such as memory hub 1205. The connections between the memory hub 1205 and the I/O unit 1304 form a communication link 1213. Within the parallel processing unit 1302, the I/O unit 1304 connects with a host interface 1306 and a memory crossbar 1316, where the host interface 1306 receives commands directed to performing processing operations and the memory crossbar 1316 receives commands directed to performing memory operations.

When the host interface 1306 receives a command buffer via the I/O unit 1304, the host interface 1306 can direct work operations to perform those commands to a front end 1308. In some examples the front end 1308 couples with a scheduler 1310, which is configured to distribute commands or other work items to a processing cluster array 1312. The scheduler 1310 ensures that the processing cluster array 1312 is properly configured and in a valid state before tasks are distributed to the processing clusters of the processing cluster array 1312. The scheduler 1310 may be implemented via firmware logic executing on a microcontroller. The microcontroller implemented scheduler 1310 is configurable to perform complex scheduling and work distribution operations at coarse and fine granularity, enabling rapid preemption and context switching of threads executing on the processing cluster array 1312. Preferably, the host software can prove workloads for scheduling on the processing cluster array 1312 via one of multiple graphics processing doorbells. In other examples, polling for new workloads or interrupts can be used to identify or indicate availability of work to perform. The workloads can then be automatically distributed across the processing cluster array 1312 by the scheduler 1310 logic within the scheduler microcontroller.

The processing cluster array 1312 can include up to “N” processing clusters (e.g., cluster 1314A, cluster 1314B, through cluster 1314N). Each cluster 1314A-1314N of the processing cluster array 1312 can execute a large number of concurrent threads. The scheduler 1310 can allocate work to the clusters 1314A-1314N of the processing cluster array 1312 using various scheduling and/or work distribution algorithms, which may vary depending on the workload arising for each type of program or computation. The scheduling can be handled dynamically by the scheduler 1310 or can be assisted in part by compiler logic during compilation of program logic configured for execution by the processing cluster array 1312. Optionally, different clusters 1314A-1314N of the processing cluster array 1312 can be allocated for processing different types of programs or for performing different types of computations.

The processing cluster array 1312 can be configured to perform various types of parallel processing operations. For example, the processing cluster array 1312 is configured to perform general-purpose parallel compute operations. For example, the processing cluster array 1312 can include logic to execute processing tasks including filtering of video and/or audio data, performing modeling operations, including physics operations, and performing data transformations.

The processing cluster array 1312 is configured to perform parallel graphics processing operations. In such examples in which the parallel processor 1300 is configured to perform graphics processing operations, the processing cluster array 1312 can include additional logic to support the execution of such graphics processing operations, including, but not limited to texture sampling logic to perform texture operations, as well as tessellation logic and other vertex processing logic. Additionally, the processing cluster array 1312 can be configured to execute graphics processing related shader programs such as, but not limited to vertex shaders, tessellation shaders, geometry shaders, and pixel shaders. The parallel processing unit 1302 can transfer data from system memory via the I/O unit 1304 for processing. During processing the transferred data can be stored to on-chip memory (e.g., parallel processor memory 1322) during processing, then written back to system memory.

In examples in which the parallel processing unit 1302 is used to perform graphics processing, the scheduler 1310 may be configured to divide the processing workload into approximately equal sized tasks, to better enable distribution of the graphics processing operations to multiple clusters 1314A-1314N of the processing cluster array 1312. In some of these examples, portions of the processing cluster array 1312 can be configured to perform different types of processing. For example, a first portion may be configured to perform vertex shading and topology generation, a second portion may be configured to perform tessellation and geometry shading, and a third portion may be configured to perform pixel shading or other screen space operations, to produce a rendered image for display. Intermediate data produced by one or more of the clusters 1314A-1314N may be stored in buffers to allow the intermediate data to be transmitted between clusters 1314A-1314N for further processing.

During operation, the processing cluster array 1312 can receive processing tasks to be executed via the scheduler 1310, which receives commands defining processing tasks from front end 1308. For graphics processing operations, processing tasks can include indices of data to be processed, e.g., surface (patch) data, primitive data, vertex data, and/or pixel data, as well as state parameters and commands defining how the data is to be processed (e.g., what program is to be executed). The scheduler 1310 may be configured to fetch the indices corresponding to the tasks or may receive the indices from the front end 1308. The front end 1308 can be configured to ensure the processing cluster array 1312 is configured to a valid state before the workload specified by incoming command buffers (e.g., batch-buffers, push buffers, etc.) is initiated.

Each of the one or more instances of the parallel processing unit 1302 can couple with parallel processor memory 1322. The parallel processor memory 1322 can be accessed via the memory crossbar 1316, which can receive memory requests from the processing cluster array 1312 as well as the I/O unit 1304. The memory crossbar 1316 can access the parallel processor memory 1322 via a memory interface 1318. The memory interface 1318 can include multiple partition units (e.g., partition unit 1320A, partition unit 1320B, through partition unit 1320N) that can each couple to a portion (e.g., memory unit) of parallel processor memory 1322. The number of partition units 1320A-1320N may be configured to be equal to the number of memory units, such that a first partition unit 1320A has a corresponding first memory unit 1324A, a second partition unit 1320B has a corresponding second memory unit 1324B, and an Nth partition unit 1320N has a corresponding Nth memory unit 1324N. In other examples, the number of partition units 1320A-1320N may not be equal to the number of memory devices.

The memory units 1324A-1324N can include various types of memory devices, including dynamic random-access memory (DRAM) or graphics random access memory, such as synchronous graphics random access memory (SGRAM), including graphics double data rate (GDDR) memory. Optionally, the memory units 1324A-1324N may also include 3D stacked memory, including but not limited to high bandwidth memory (HBM). Persons skilled in the art will appreciate that the specific implementation of the memory units 1324A-1324N can vary and can be selected from one of various conventional designs. Render targets, such as frame buffers or texture maps may be stored across the memory units 1324A-1324N, allowing partition units 1320A-1320N to write portions of each render target in parallel to efficiently use the available bandwidth of parallel processor memory 1322. In some examples, a local instance of the parallel processor memory 1322 may be excluded in favor of a unified memory design that utilizes system memory in conjunction with local cache memory.

Optionally, any one of the clusters 1314A-1314N of the processing cluster array 1312 has the ability to process data that will be written to any of the memory units 1324A-1324N within parallel processor memory 1322. The memory crossbar 1316 can be configured to transfer the output of each cluster 1314A-1314N to any partition unit 1320A-1320N or to another cluster 1314A-1314N, which can perform additional processing operations on the output. Each cluster 1314A-1314N can communicate with the memory interface 1318 through the memory crossbar 1316 to read from or write to various external memory devices. In one of the examples with the memory crossbar 1316 the memory crossbar 1316 has a connection to the memory interface 1318 to communicate with the I/O unit 1304, as well as a connection to a local instance of the parallel processor memory 1322, enabling the processing units within the different processing clusters 1314A-1314N to communicate with system memory or other memory that is not local to the parallel processing unit 1302. Generally, the memory crossbar 1316 may, for example, be able to use virtual channels to separate traffic streams between the clusters 1314A-1314N and the partition units 1320A-1320N.

While a single instance of the parallel processing unit 1302 is illustrated within the parallel processor 1300, any number of instances of the parallel processing unit 1302 can be included. For example, multiple instances of the parallel processing unit 1302 can be provided on a single add-in card, or multiple add-in cards can be interconnected. For example, the parallel processor 1300 can be an add-in device, such as add-in device(s) 1220 of FIG. 12, which may be a graphics card such as a discrete graphics card that includes one or more GPUs, one or more memory devices, and device-to-device or network or fabric interfaces. The different instances of the parallel processing unit 1302 can be configured to inter-operate even if the different instances have different numbers of processing cores, different amounts of local parallel processor memory, and/or other configuration differences. Optionally, some instances of the parallel processing unit 1302 can include higher precision floating point units relative to other instances. Systems incorporating one or more instances of the parallel processing unit 1302 or the parallel processor 1300 can be implemented in a variety of configurations and form factors, including but not limited to desktop, laptop, or handheld personal computers, servers, workstations, game consoles, and/or embedded systems. An orchestrator can form composite nodes for workload performance using one or more of: disaggregated processor resources, cache resources, memory resources, storage resources, and networking resources.

In some examples, the parallel processing unit 1302 can be partitioned into multiple instances. Those multiple instances can be configured to execute workloads associated with different clients in an isolated manner, enabling a pre-determined quality of service to be provided for each client. For example, each cluster 1314A-1314N can be compartmentalized and isolated from other clusters, allowing the processing cluster array 1312 to be divided into multiple compute partitions or instances. In such configuration, workloads that execute on an isolated partition are protected from faults or errors associated with a different workload that executes on a different partition. The partition units 1320A-1320N can be configured to enable a dedicated and/or isolated path to memory for the clusters 1314A-1314N associated with the respective compute partitions. This datapath isolation enables the compute resources within a partition can communicate with one or more assigned memory units 1324A-1324N without being subjected to inference by the activities of other partitions.

FIG. 13B is a block diagram of a partition unit 1320. The partition unit 1320 may be an instance of one of the partition units 1320A-1320N of FIG. 13A. As illustrated, the partition unit 1320 includes an L2 cache 1321, a frame buffer interface 1325, and a ROP 1326 (raster operations unit). The L2 cache 1321 is a read/write cache that is configured to perform load and store operations received from the memory crossbar 1316 and ROP 1326. Read misses and urgent write-back requests are output by L2 cache 1321 to frame buffer interface 1325 for processing. Updates can also be sent to the frame buffer via the frame buffer interface 1325 for processing. In some examples the frame buffer interface 1325 interfaces with one of the memory units in parallel processor memory, such as the memory units 1324A-1324N of FIG. 13A (e.g., within parallel processor memory 1322). The partition unit 1320 may additionally or alternatively also interface with one of the memory units in parallel processor memory via a memory controller (not shown).

In graphics applications, the ROP 1326 is a processing unit that performs raster operations such as stencil, z test, blending, and the like. The ROP 1326 then outputs processed graphics data that is stored in graphics memory. In some examples the ROP 1326 includes or couples with a CODEC 1327 that includes compression logic to compress depth or color data that is written to memory or the L2 cache 1321 and decompress depth or color data that is read from memory or the L2 cache 1321. The compression logic can be lossless compression logic that makes use of one or more of multiple compression algorithms. The type of compression that is performed by the CODEC 1327 can vary based on the statistical characteristics of the data to be compressed. For example, in some examples, delta color compression is performed on depth and color data on a per-tile basis. In some examples the CODEC 1327 includes compression and decompression logic that can compress and decompress compute data associated with machine learning operations. The CODEC 1327 can, for example, compress sparse matrix data for sparse machine learning operations. The CODEC 1327 can also compress sparse matrix data that is encoded in a sparse matrix format (e.g., coordinate list encoding (COO), compressed sparse row (CSR), compress sparse column (CSC), etc.) to generate compressed and encoded sparse matrix data. The compressed and encoded sparse matrix data can be decompressed and/or decoded before being processed by processing elements or the processing elements can be configured to consume compressed, encoded, or compressed and encoded data for processing.

The ROP 1326 may be included within each processing cluster (e.g., cluster 1314A-1314N of FIG. 13A) instead of within the partition unit 1320. In such example, read and write requests for pixel data are transmitted over the memory crossbar 1316 instead of pixel fragment data. The processed graphics data may be displayed on a display device, such as one of the one or more display device(s) 1210A-1210B of FIG. 12, routed for further processing by the processor(s) 1202, or routed for further processing by one of the processing entities within the parallel processor 1300 of FIG. 13A.

FIG. 13C is a block diagram of a processing cluster 1314 within a parallel processing unit. For example, the processing cluster is an instance of one of the processing clusters 1314A-1314N of FIG. 13A. The processing cluster 1314 can be configured to execute many threads in parallel, where the term “thread” refers to an instance of a particular program executing on a particular set of input data. Optionally, single-instruction, multiple-data (SIMD) instruction issue techniques may be used to support parallel execution of a large number of threads without providing multiple independent instruction units. Alternatively, single-instruction, multiple-thread (SIMT) techniques may be used to support parallel execution of a large number of generally synchronized threads, using a common instruction unit configured to issue instructions to a set of processing engines within each one of the processing clusters. Unlike a SIMD execution regime, where all processing engines typically execute identical instructions, SIMT execution allows different threads to more readily follow divergent execution paths through a given thread program. Persons skilled in the art will understand that a SIMD processing regime represents a functional subset of a SIMT processing regime.

Operation of the processing cluster 1314 can be controlled via a pipeline manager 1332 that distributes processing tasks to SIMT parallel processors. The pipeline manager 1332 receives instructions from the scheduler 1310 of FIG. 13A and manages execution of those instructions via a graphics multiprocessor 1334 and/or a texture unit 1336. The graphics multiprocessor 1334 is an exemplary instance of a SIMT parallel processor. However, various types of SIMT parallel processors of differing architectures may be included within the processing cluster 1314. One or more instances of the graphics multiprocessor 1334 can be included within a processing cluster 1314. The graphics multiprocessor 1334 can process data and a data crossbar 1340 can be used to distribute the processed data to one of multiple possible destinations, including other shader units. The pipeline manager 1332 can facilitate the distribution of processed data by specifying destinations for processed data to be distributed via the data crossbar 1340.

Each graphics multiprocessor 1334 within the processing cluster 1314 can include an identical set of functional execution logic (e.g., arithmetic logic units, load-store units, etc.). The functional execution logic can be configured in a pipelined manner in which new instructions can be issued before previous instructions are complete. The functional execution logic supports a variety of operations including integer and floating-point arithmetic, comparison operations, Boolean operations, bit-shifting, and computation of various algebraic functions. The same functional-unit hardware could be leveraged to perform different operations and any combination of functional units may be present.

The instructions transmitted to the processing cluster 1314 constitute a thread. A set of threads executing across the set of parallel processing engines is a thread group. A thread group executes the same program on different input data. Each thread within a thread group can be assigned to a different processing engine within a graphics multiprocessor 1334. A thread group may include fewer threads than the number of processing engines within the graphics multiprocessor 1334. When a thread group includes fewer threads than the number of processing engines, one or more of the processing engines may be idle during cycles in which that thread group is being processed. A thread group may also include more threads than the number of processing engines within the graphics multiprocessor 1334. When the thread group includes more threads than the number of processing engines within the graphics multiprocessor 1334, processing can be performed over consecutive clock cycles. Optionally, multiple thread groups can be executed concurrently on the graphics multiprocessor 1334.

The graphics multiprocessor 1334 may include an internal cache memory to perform load and store operations. Optionally, the graphics multiprocessor 1334 can forego an internal cache and use a cache memory (e.g., level 1 (L1) cache 1348) within the processing cluster 1314. Each graphics multiprocessor 1334 also has access to level 2 (L2) caches within the partition units (e.g., partition units 1320A-1320N of FIG. 13A) that are shared among all processing clusters 1314 and may be used to transfer data between threads. The graphics multiprocessor 1334 may also access off-chip global memory, which can include one or more of local parallel processor memory and/or system memory. Any memory external to the parallel processing unit 1302 may be used as global memory. Embodiments in which the processing cluster 1314 includes multiple instances of the graphics multiprocessor 1334 can share common instructions and data, which may be stored in the L1 cache 1348.

Each processing cluster 1314 may include an MMU 1345 (memory management unit) that is configured to map virtual addresses into physical addresses. In other examples, one or more instances of the MMU 1345 may reside within the memory interface 1318 of FIG. 13A. The MMU 1345 includes a set of page table entries (PTEs) used to map a virtual address to a physical address of a tile and optionally a cache line index. The MMU 1345 may include address translation lookaside buffers (TLB) or caches that may reside within the graphics multiprocessor 1334 or the L1 cache 1348 of processing cluster 1314. The physical address is processed to distribute surface data access locality to allow efficient request interleaving among partition units. The cache line index may be used to determine whether a request for a cache line is a hit or miss.

In graphics and computing applications, a processing cluster 1314 may be configured such that each graphics multiprocessor 1334 is coupled to a texture unit 1336 for performing texture mapping operations, e.g., determining texture sample positions, reading texture data, and filtering the texture data. Texture data is read from an internal texture L1 cache (not shown) or in some examples from the L1 cache within graphics multiprocessor 1334 and is fetched from an L2 cache, local parallel processor memory, or system memory, as needed. Each graphics multiprocessor 1334 outputs processed tasks to the data crossbar 1340 to provide the processed task to another processing cluster 1314 for further processing or to store the processed task in an L2 cache, local parallel processor memory, or system memory via the memory crossbar 1316. A preROP 1342 (pre-raster operations unit) is configured to receive data from graphics multiprocessor 1334, direct data to ROP units, which may be located with partition units as described herein (e.g., partition units 1320A-1320N of FIG. 13A). The preROP 1342 unit can perform optimizations for color blending, organize pixel color data, and perform address translations.

It will be appreciated that the core architecture described herein is illustrative and that variations and modifications are possible. Any number of processing units, e.g., graphics multiprocessor 1334, texture units 1336, preROPs 1342, etc., may be included within a processing cluster 1314. Further, while only one processing cluster 1314 is shown, a parallel processing unit as described herein may include any number of instances of the processing cluster 1314. Optionally, each processing cluster 1314 can be configured to operate independently of other processing clusters 1314 using separate and distinct processing units, L1 caches, L2 caches, etc.

FIG. 13D shows an example of the graphics multiprocessor 1334 in which the graphics multiprocessor 1334 couples with the pipeline manager 1332 of the processing cluster 1314. The graphics multiprocessor 1334 has an execution pipeline including but not limited to an instruction cache 1352, an instruction unit 1354, an address mapping unit 1356, a register file 1358, one or more general purpose graphics processing unit (GPGPU) cores 1362, and one or more load/store units 1366. The GPGPU cores 1362 and load/store units 1366 are coupled with cache memory 1372 and shared memory 1370 via a memory and cache interconnect 1368. The graphics multiprocessor 1334 may additionally include tensor and/or ray-tracing cores 1363 that include hardware logic to accelerate matrix and/or ray-tracing operations.

The instruction cache 1352 may receive a stream of instructions to execute from the pipeline manager 1332. The instructions are cached in the instruction cache 1352 and dispatched for execution by the instruction unit 1354. The instruction unit 1354 can dispatch instructions as thread groups (e.g., warps), with each thread of the thread group assigned to a different execution unit within GPGPU core 1362. An instruction can access any of a local, shared, or global address space by specifying an address within a unified address space. The address mapping unit 1356 can be used to translate addresses in the unified address space into a distinct memory address that can be accessed by the load/store units 1366.

The register file 1358 provides a set of registers for the functional units of the graphics multiprocessor 1334. The register file 1358 provides temporary storage for operands connected to the data paths of the functional units (e.g., GPGPU cores 1362, load/store units 1366) of the graphics multiprocessor 1334. The register file 1358 may be divided between each of the functional units such that each functional unit is allocated a dedicated portion of the register file 1358. For example, the register file 1358 may be divided between the different warps being executed by the graphics multiprocessor 1334.

The GPGPU cores 1362 can each include floating point units (FPUs) and/or integer arithmetic logic units (ALUs) that are used to execute instructions of the graphics multiprocessor 1334. In some implementations, the GPGPU cores 1362 can include hardware logic that may otherwise reside within the tensor and/or ray-tracing cores 1363. The GPGPU cores 1362 can be similar in architecture or can differ in architecture. For example and in some examples, a first portion of the GPGPU cores 1362 include a single precision FPU and an integer ALU while a second portion of the GPGPU cores include a double precision FPU. Optionally, the FPUs can implement the IEEE 754-2008 standard for floating point arithmetic or enable variable precision floating point arithmetic. The graphics multiprocessor 1334 can additionally include one or more fixed function or special function units to perform specific functions such as copy rectangle or pixel blending operations. One or more of the GPGPU cores can also include fixed or special function logic.

The GPGPU cores 1362 may include SIMD logic capable of performing a single instruction on multiple sets of data. Optionally, GPGPU cores 1362 can physically execute SIMD4, SIMD8, and SIMD16 instructions and logically execute SIMD1, SIMD2, and SIMD32 instructions. The SIMD instructions for the GPGPU cores can be generated at compile time by a shader compiler or automatically generated when executing programs written and compiled for single program multiple data (SPMD) or SIMT architectures. Multiple threads of a program configured for the SIMT execution model can be executed via a single SIMD instruction. For example and in some examples, eight SIMT threads that perform the same or similar operations can be executed in parallel via a single SIMD8 logic unit.

The memory and cache interconnect 1368 is an interconnect network that connects each of the functional units of the graphics multiprocessor 1334 to the register file 1358 and to the shared memory 1370. For example, the memory and cache interconnect 1368 is a crossbar interconnect that allows the load/store unit 1366 to implement load and store operations between the shared memory 1370 and the register file 1358. The register file 1358 can operate at the same frequency as the GPGPU cores 1362, thus data transfer between the GPGPU cores 1362 and the register file 1358 is very low latency. The shared memory 1370 can be used to enable communication between threads that execute on the functional units within the graphics multiprocessor 1334. The cache memory 1372 can be used as a data cache for example, to cache texture data communicated between the functional units and the texture unit 1336. The shared memory 1370 can also be used as a program managed cached. The shared memory 1370 and the cache memory 1372 can couple with the data crossbar 1340 to enable communication with other components of the processing cluster. Threads executing on the GPGPU cores 1362 can programmatically store data within the shared memory in addition to the automatically cached data that is stored within the cache memory 1372.

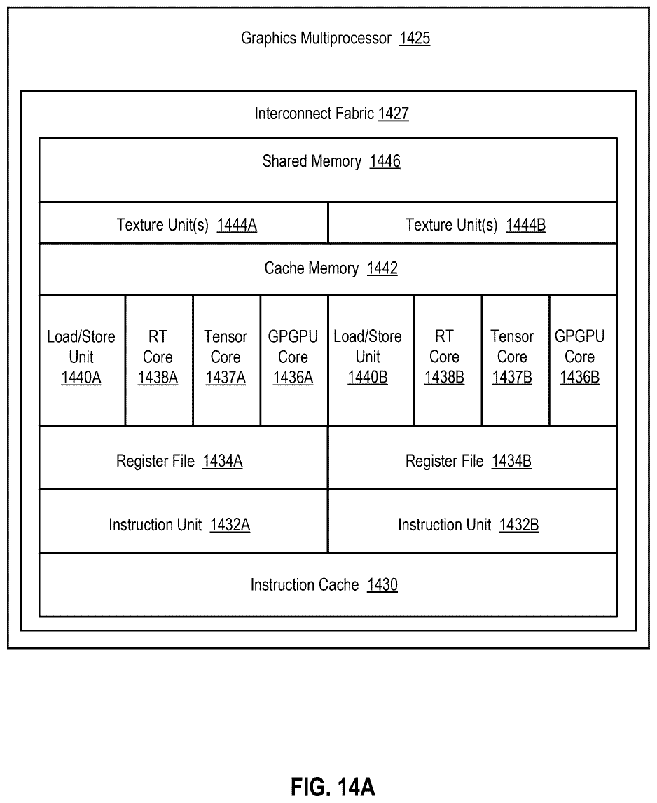

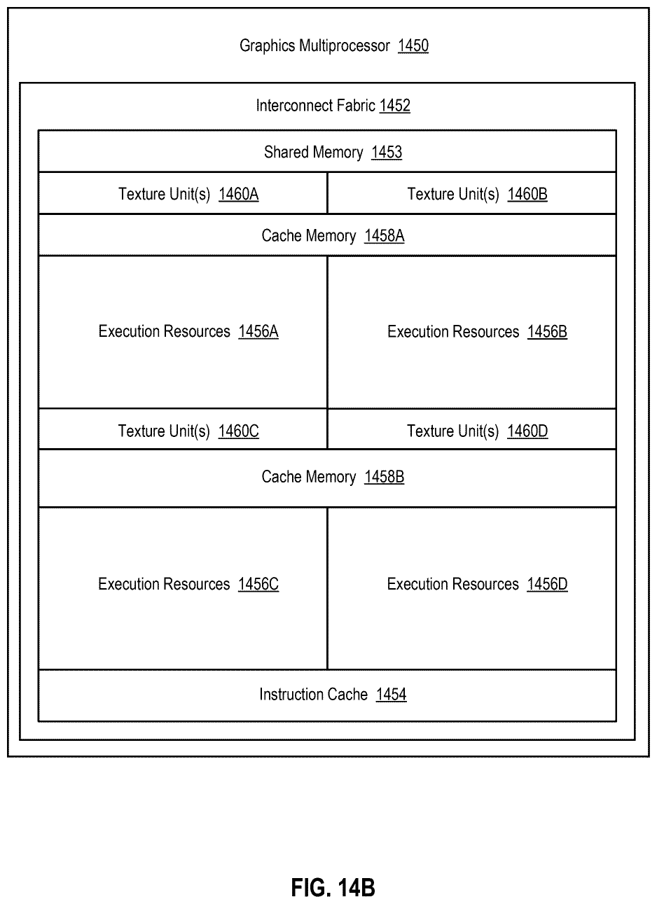

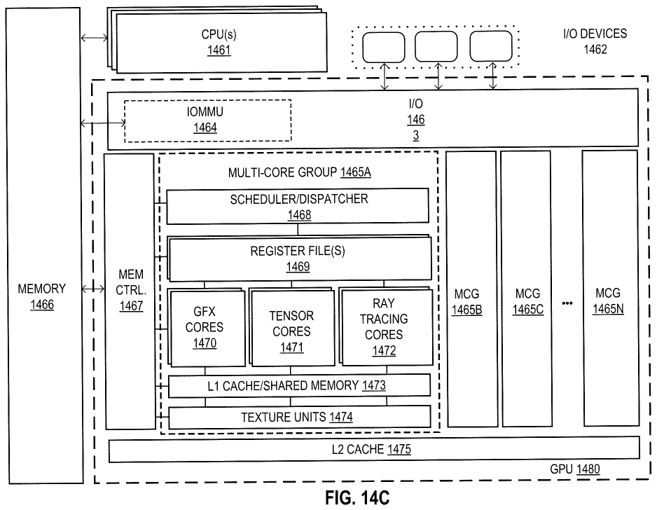

FIGS. 14A-14C illustrate additional graphics multiprocessors, according to examples. FIG. 14A-14B illustrate graphics multiprocessors 1425, 1450, which are related to the graphics multiprocessor 1334 of FIG. 13C and may be used in place of one of those. Therefore, the disclosure of any features in combination with the graphics multiprocessor 1334 herein also discloses a corresponding combination with the graphics multiprocessors 1425, 1450, but is not limited to such. FIG. 14C illustrates a graphics processing unit (GPU) 1480 which includes dedicated sets of graphics processing resources arranged into multi-core groups 1465A-1465N, which correspond to the graphics multiprocessors 1425, 1450. The illustrated graphics multiprocessors 1425, 1450 and the multi-core groups 1465A-1465N can be streaming multiprocessors (SM) capable of simultaneous execution of a large number of execution threads.

The graphics multiprocessor 1425 of FIG. 14A includes multiple additional instances of execution resource units relative to the graphics multiprocessor 1334 of FIG. 13D. For example, the graphics multiprocessor 1425 can include multiple instances of the instruction unit 1432A-1432B, register file 1434A-1434B, and texture unit(s) 1444A-1444B. The graphics multiprocessor 1425 also includes multiple sets of graphics or compute execution units (e.g., GPGPU core 1436A-1436B, tensor core 1437A-1437B, ray-tracing core 1438A-1438B) and multiple sets of load/store units 1440A-1440B. The execution resource units have a common instruction cache 1430, texture and/or data cache memory 1442, and shared memory 1446.

The various components can communicate via an interconnect fabric 1427. The interconnect fabric 1427 may include one or more crossbar switches to enable communication between the various components of the graphics multiprocessor 1425. The interconnect fabric 1427 may be a separate, high-speed network fabric layer upon which each component of the graphics multiprocessor 1425 is stacked. The components of the graphics multiprocessor 1425 communicate with remote components via the interconnect fabric 1427. For example, the cores 1436A-1436B, 1437A-1437B, and 1438A-1438B can each communicate with shared memory 1446 via the interconnect fabric 1427. The interconnect fabric 1427 can arbitrate communication within the graphics multiprocessor 1425 to ensure a fair bandwidth allocation between components.

The graphics multiprocessor 1450 of FIG. 14B includes multiple sets of execution resources 1456A-1456D, where each set of execution resource includes multiple instruction units, register files, GPGPU cores, and load store units, as illustrated in FIG. 13D and FIG. 14A. The execution resources 1456A-1456D can work in concert with texture unit(s) 1460A-1460D for texture operations, while sharing an instruction cache 1454, and shared memory 1453. For example, the execution resources 1456A-1456D can share an instruction cache 1454 and shared memory 1453, as well as multiple instances of a texture and/or data cache memory 1458A-1458B. The various components can communicate via an interconnect fabric 1452 similar to the interconnect fabric 1427 of FIG. 14A.

Persons skilled in the art will understand that the architecture described in FIG. 1, 13A-13D, and 14A-14B are descriptive and not limiting as to the scope of the present examples. Thus, the techniques described herein may be implemented on any properly configured processing unit, including, without limitation, one or more mobile application processors, one or more desktop or server central processing units (CPUs) including multi-core CPUs, one or more parallel processing units, such as the parallel processing unit 1302 of FIG. 13A, as well as one or more graphics processors or special purpose processing units, without departure from the scope of the examples described herein.

The parallel processor or GPGPU as described herein may be communicatively coupled to host/processor cores to accelerate graphics operations, machine-learning operations, pattern analysis operations, and various general-purpose GPU (GPGPU) functions. The GPU may be communicatively coupled to the host processor/cores over a bus or other interconnect (e.g., a high-speed interconnect such as PCIe, NVLink, or other known protocols, standardized protocols, or proprietary protocols). In other examples, the GPU may be integrated on the same package or chip as the cores and communicatively coupled to the cores over an internal processor bus/interconnect (i.e., internal to the package or chip). Regardless of the manner in which the GPU is connected, the processor cores may allocate work to the GPU in the form of sequences of commands/instructions contained in a work descriptor. The GPU then uses dedicated circuitry/logic for efficiently processing these commands/instructions.

FIG. 14C illustrates a graphics processing unit (GPU) 1480 which includes dedicated sets of graphics processing resources arranged into multi-core groups 1465A-1465N. While the details of only a single multi-core group 1465A are provided, it will be appreciated that the other multi-core groups 1465B-1465N may be equipped with the same or similar sets of graphics processing resources. Details described with respect to the multi-core groups 1465A-1465N may also apply to any graphics multiprocessor 1334, 1425, 1450 described herein.

As illustrated, a multi-core group 1465A may include a set of graphics cores 1470, a set of tensor cores 1471, and a set of ray tracing cores 1472. A scheduler/dispatcher 1468 schedules and dispatches the graphics threads for execution on the various cores 1470, 1471, 1472. A set of register files 1469 store operand values used by the cores 1470, 1471, 1472 when executing the graphics threads. These may include, for example, integer registers for storing integer values, floating point registers for storing floating point values, vector registers for storing packed data elements (integer and/or floating-point data elements) and tile registers for storing tensor/matrix values. The tile registers may be implemented as combined sets of vector registers.

One or more combined level 1 (L1) caches and shared memory units 1473 store graphics data such as texture data, vertex data, pixel data, ray data, bounding volume data, etc., locally within each multi-core group 1465A. One or more texture units 1474 can also be used to perform texturing operations, such as texture mapping and sampling. A Level 2 (L2) cache 1475 shared by all or a subset of the multi-core groups 1465A-1465N stores graphics data and/or instructions for multiple concurrent graphics threads. As illustrated, the L2 cache 1475 may be shared across a plurality of multi-core groups 1465A-1465N. One or more memory controllers 1467 couple the GPU 1480 to a memory 1466 which may be a system memory (e.g., DRAM) and/or a dedicated graphics memory (e.g., GDDR6 memory).

Input/output (I/O) circuitry 1463 couples the GPU 1480 to one or more I/O devices 1462 such as digital signal processors (DSPs), network controllers, or user input devices. An on-chip interconnect may be used to couple the I/O devices 1462 to the GPU 1480 and memory 1466. One or more I/O memory management units (IOMMUs) 1464 of the I/O circuitry 1463 couple the I/O devices 1462 directly to the system memory 1466. Optionally, the IOMMU 1464 manages multiple sets of page tables to map virtual addresses to physical addresses in system memory 1466. The I/O devices 1462, CPU(s) 1461, and GPU(s) 1480 may then share the same virtual address space.

In one implementation of the IOMMU 1464, the IOMMU 1464 supports virtualization. In this case, it may manage a first set of page tables to map guest/graphics virtual addresses to guest/graphics physical addresses and a second set of page tables to map the guest/graphics physical addresses to system/host physical addresses (e.g., within system memory 1466). The base addresses of each of the first and second sets of page tables may be stored in control registers and swapped out on a context switch (e.g., so that the new context is provided with access to the relevant set of page tables). While not illustrated in FIG. 14C, each of the cores 1470, 1471, 1472 and/or multi-core groups 1465A-1465N may include translation lookaside buffers (TLBs) to cache guest virtual to guest physical translations, guest physical to host physical translations, and guest virtual to host physical translations.

The CPU(s) 1461, GPUs 1480, and I/O devices 1462 may be integrated on a single semiconductor chip and/or chip package. The illustrated memory 1466 may be integrated on the same chip or may be coupled to the memory controllers 1467 via an off-chip interface. In one implementation, the memory 1466 comprises GDDR6 memory which shares the same virtual address space as other physical system-level memories, although the underlying principles described herein are not limited to this specific implementation.

The tensor cores 1471 may include a plurality of execution units specifically designed to perform matrix operations, which are the fundamental compute operation used to perform deep learning operations. For example, simultaneous matrix multiplication operations may be used for neural network training and inferencing. The tensor cores 1471 may perform matrix processing using a variety of operand precisions including single precision floating-point (e.g., 32 bits), half-precision floating point (e.g., 16 bits), integer words (16 bits), bytes (8 bits), and half-bytes (4 bits). For example, a neural network implementation extracts features of each rendered scene, potentially combining details from multiple frames, to construct a high-quality final image.

In deep learning implementations, parallel matrix multiplication work may be scheduled for execution on the tensor cores 1471. The training of neural networks, in particular, requires a significant number of matrix dot product operations. In order to process an inner-product formulation of an N×N×N matrix multiply, the tensor cores 1471 may include at least N dot-product processing elements. Before the matrix multiply begins, one entire matrix is loaded into tile registers and at least one column of a second matrix is loaded each cycle for N cycles. Each cycle, there are N dot products that are processed.

Matrix elements may be stored at different precisions depending on the particular implementation, including 16-bit words, 8-bit bytes (e.g., INT8) and 4-bit half-bytes (e.g., INT4). Different precision modes may be specified for the tensor cores 1471 to ensure that the most efficient precision is used for different workloads (e.g., such as inferencing workloads which can tolerate quantization to bytes and half-bytes). Supported formats additionally include 64-bit floating point (FP64) and non-IEEE floating point formats such as the bfloat16 format (e.g., Brain floating point), a 16-bit floating point format with one sign bit, eight exponent bits, and eight significand bits, of which seven are explicitly stored. One example includes support for a reduced precision tensor-float (TF32) mode, which performs computations using the range of FP32 (8-bits) and the precision of FP16 (10-bits). Reduced precision TF32 operations can be performed on FP32 inputs and produce FP32 outputs at higher performance relative to FP32 and increased precision relative to FP16. In some examples, one or more 8-bit floating point formats (FP8) are supported.

In some examples the tensor cores 1471 support a sparse mode of operation for matrices in which the vast majority of values are zero. The tensor cores 1471 include support for sparse input matrices that are encoded in a sparse matrix representation (e.g., coordinate list encoding (COO), compressed sparse row (CSR), compress sparse column (CSC), etc.). The tensor cores 1471 also include support for compressed sparse matrix representations in the event that the sparse matrix representation may be further compressed. Compressed, encoded, and/or compressed and encoded matrix data, along with associated compression and/or encoding metadata, can be read by the tensor cores 1471 and the non-zero values can be extracted. For example, for a given input matrix A, a non-zero value can be loaded from the compressed and/or encoded representation of at least a portion of matrix A. Based on the location in matrix A for the non-zero value, which may be determined from index or coordinate metadata associated with the non-zero value, a corresponding value in input matrix B may be loaded. Depending on the operation to be performed (e.g., multiply), the load of the value from input matrix B may be bypassed if the corresponding value is a zero value. In some examples, the pairings of values for certain operations, such as multiply operations, may be pre-scanned by scheduler logic and only operations between non-zero inputs are scheduled. Depending on the dimensions of matrix A and matrix B and the operation to be performed, output matrix C may be dense or sparse. Where output matrix C is sparse and depending on the configuration of the tensor cores 1471, output matrix C may be output in a compressed format, a sparse encoding, or a compressed sparse encoding.

The ray tracing cores 1472 may accelerate ray tracing operations for both real-time ray tracing and non-real-time ray tracing implementations. In particular, the ray tracing cores 1472 may include ray traversal/intersection circuitry for performing ray traversal using bounding volume hierarchies (BVHs) and identifying intersections between rays and primitives enclosed within the BVH volumes. The ray tracing cores 1472 may also include circuitry for performing depth testing and culling (e.g., using a Z buffer or similar arrangement). In one implementation, the ray tracing cores 1472 perform traversal and intersection operations in concert with the image denoising techniques described herein, at least a portion of which may be executed on the tensor cores 1471. For example, the tensor cores 1471 may implement a deep learning neural network to perform denoising of frames generated by the ray tracing cores 1472. However, the CPU(s) 1461, graphics cores 1470, and/or ray tracing cores 1472 may also implement all or a portion of the denoising and/or deep learning algorithms.

In addition, as described above, a distributed approach to denoising may be employed in which the GPU 1480 is in a computing device coupled to other computing devices over a network or high-speed interconnect. In this distributed approach, the interconnected computing devices may share neural network learning/training data to improve the speed with which the overall system learns to perform denoising for different types of image frames and/or different graphics applications.

The ray tracing cores 1472 may process all BVH traversal and/or ray-primitive intersections, saving the graphics cores 1470 from being overloaded with thousands of instructions per ray. For example, each ray tracing core 1472 includes a first set of specialized circuitry for performing bounding box tests (e.g., for traversal operations) and/or a second set of specialized circuitry for performing the ray-triangle intersection tests (e.g., intersecting rays which have been traversed). Thus, for example, the multi-core group 1465A can simply launch a ray probe, and the ray tracing cores 1472 independently perform ray traversal and intersection and return hit data (e.g., a hit, no hit, multiple hits, etc.) to the thread context. The other cores 1470, 1471 are freed to perform other graphics or compute work while the ray tracing cores 1472 perform the traversal and intersection operations.

Optionally, each ray tracing core 1472 may include a traversal unit to perform BVH testing operations and/or an intersection unit which performs ray-primitive intersection tests. The intersection unit generates a “hit”, “no hit”, or “multiple hit” response, which it provides to the appropriate thread. During the traversal and intersection operations, the execution resources of the other cores (e.g., graphics cores 1470 and tensor cores 1471) are freed to perform other forms of graphics work.

In some examples described below, a hybrid rasterization/ray tracing approach is used in which work is distributed between the graphics cores 1470 and ray tracing cores 1472.

The ray tracing cores 1472 (and/or other cores 1470, 1471) may include hardware support for a ray tracing instruction set such as Microsoft's DirectX Ray Tracing (DXR) which includes a DispatchRays command, as well as ray-generation, closest-hit, any-hit, and miss shaders, which enable the assignment of unique sets of shaders and textures for each object. Another ray tracing platform which may be supported by the ray tracing cores 1472, graphics cores 1470 and tensor cores 1471 is Vulkan API (e.g., Vulkan version 1.1.85 and later). Note, however, that the underlying principles described herein are not limited to any particular ray tracing ISA.

In general, the various cores 1472, 1471, 1470 may support a ray tracing instruction set that includes instructions/functions for one or more of ray generation, closest hit, any hit, ray-primitive intersection, per-primitive and hierarchical bounding box construction, miss, visit, and exceptions. More specifically, some examples includes ray tracing instructions to perform one or more of the following functions:
Ray Generation—Ray generation instructions may be executed for each pixel, sample, or other user-defined work assignment.
Closest Hit—A closest hit instruction may be executed to locate the closest intersection point of a ray with primitives within a scene.
Any Hit—An any hit instruction identifies multiple intersections between a ray and primitives within a scene, potentially to identify a new closest intersection point.
Intersection—An intersection instruction performs a ray-primitive intersection test and outputs a result.
Per-primitive Bounding box Construction—This instruction builds a bounding box around a given primitive or group of primitives (e.g., when building a new BVH or other acceleration data structure).
Miss-Indicates that a ray misses all geometry within a scene, or specified region of a scene.
Visit—Indicates the child volumes a ray will traverse.
Exceptions—Includes various types of exception handlers (e.g., invoked for various error conditions).

In some examples the ray tracing cores 1472 may be adapted to accelerate general-purpose compute operations that can be accelerated using computational techniques that are analogous to ray intersection tests. A compute framework can be provided that enables shader programs to be compiled into low level instructions and/or primitives that perform general-purpose compute operations via the ray tracing cores. Exemplary computational problems that can benefit from compute operations performed on the ray tracing cores 1472 include computations involving beam, wave, ray, or particle propagation within a coordinate space. Interactions associated with that propagation can be computed relative to a geometry or mesh within the coordinate space. For example, computations associated with electromagnetic signal propagation through an environment can be accelerated via the use of instructions or primitives that are executed via the ray tracing cores. Diffraction and reflection of the signals by objects in the environment can be computed as direct ray-tracing analogies.

Ray tracing cores 1472 can also be used to perform computations that are not directly analogous to ray tracing. For example, mesh projection, mesh refinement, and volume sampling computations can be accelerated using the ray tracing cores 1472. Generic coordinate space calculations, such as nearest neighbor calculations can also be performed. For example, the set of points near a given point can be discovered by defining a bounding box in the coordinate space around the point. BVH and ray probe logic within the ray tracing cores 1472 can then be used to determine the set of point intersections within the bounding box. The intersections constitute the origin point and the nearest neighbors to that origin point. Computations that are performed using the ray tracing cores 1472 can be performed in parallel with computations performed on the graphics cores 1472 and tensor cores 1471. A shader compiler can be configured to compile a compute shader or other general-purpose graphics processing program into low level primitives that can be parallelized across the graphics cores 1470, tensor cores 1471, and ray tracing cores 1472.

Building larger and larger silicon dies is challenging for a variety of reasons. As silicon dies become larger, manufacturing yields become smaller and process technology requirements for different components may diverge. On the other hand, in order to have a high-performance system, key components should be interconnected by high speed, high bandwidth, low latency interfaces. These contradicting needs pose a challenge to high performance chip development.

Embodiments described herein provide techniques to disaggregate an architecture of a system on a chip integrated circuit into multiple distinct chiplets that can be packaged onto a common chassis. In some examples, a graphics processing unit or parallel processor is composed from diverse silicon chiplets that are separately manufactured. A chiplet is an at least partially packaged integrated circuit that includes distinct units of logic that can be assembled with other chiplets into a larger package. A diverse set of chiplets with different IP core logic can be assembled into a single device. Additionally the chiplets can be integrated into a base die or base chiplet using active interposer technology. The concepts described herein enable the interconnection and communication between the different forms of IP within the GPU. The development of IPs on different process may be mixed. This avoids the complexity of converging multiple IPs, especially on a large SoC with several flavors IPs, to the same process.

Enabling the use of multiple process technologies improves the time to market and provides a cost-effective way to create multiple product SKUs. For customers, this means getting products that are more tailored to their requirements in a cost effective and timely manner. Additionally, the disaggregated IPs are more amenable to being power gated independently, components that are not in use on a given workload can be powered off, reducing overall power consumption.

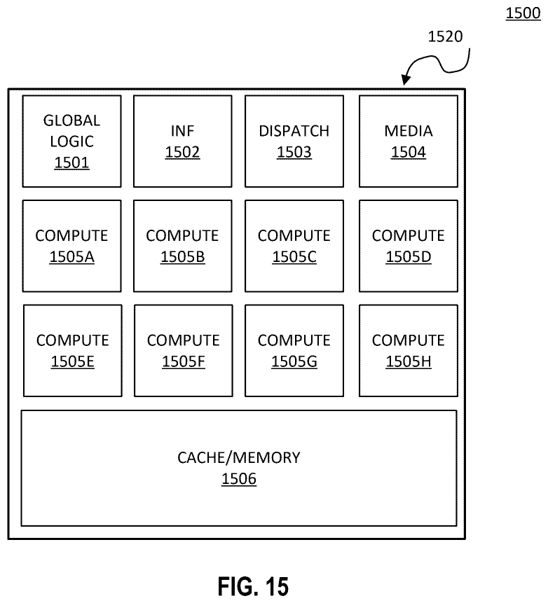

FIG. 15 shows a parallel compute system 1500, according to some examples. In some examples the parallel compute system 1500 includes a parallel processor 1520, which can be a graphics processor or compute accelerator as described herein. The parallel processor 1520 includes a global logic unit 1501, an interface 1502, a thread dispatcher 1503, a media unit 1504, a set of compute units 1505A-1505H, and a cache/memory units 1506. The global logic unit 1501, in some examples, includes global functionality for the parallel processor 1520, including device configuration registers, global schedulers, power management logic, and the like. The interface 1502 can include a front-end interface for the parallel processor 1520. The thread dispatcher 1503 can receive workloads from the interface 1502 and dispatch threads for the workload to the compute units 1505A-1505H. If the workload includes any media operations, at least a portion of those operations can be performed by the media unit 1504. The media unit can also offload some operations to the compute units 1505A-1505H. The cache/memory units 1506 can include cache memory (e.g., L3 cache) and local memory (e.g., HBM, GDDR) for the parallel processor 1520. Compute units 1505 may include units for one or more of a network or communication processor, a core, a graphics processor, a general purpose graphics processing unit (GPGPU), a neural-network processing unit (NPU), an embedded processor, a security processor, a cryptographic accelerator, a matrix accelerator, an in-memory analytics accelerator, a compression accelerator, a data streaming accelerator, or the like.

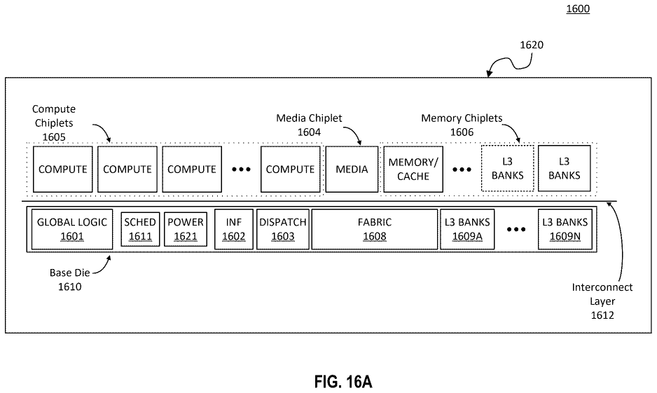

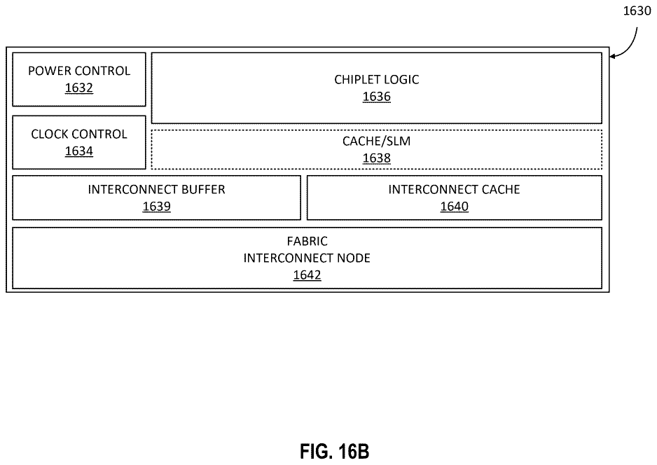

FIGS. 16A-16B illustrate a hybrid logical/physical view of a disaggregated parallel processor, according to examples described herein. FIG. 16A illustrates a disaggregated parallel compute system 1600. FIG. 16B illustrates a chiplet 1630 of the disaggregated parallel compute system 1600.

As shown in FIG. 16A, a disaggregated parallel compute system 1600 can include a parallel processor 1620 in which the various components of the parallel processor SOC are distributed across multiple chiplets. Each chiplet can be a distinct IP core that is independently designed and configured to communicate with other chiplets via one or more common interfaces. The chiplets include but are not limited to compute chiplets 1605, a media chiplet 1604, and memory chiplets 1606. Each chiplet can be separately manufactured using different process technologies. For example, compute chiplets 1605 may be manufactured using the smallest or most advanced process technology available at the time of fabrication, while memory chiplets 1606 or other chiplets (e.g., I/O, networking, etc.) may be manufactured using a larger or less advanced process technologies.

The various chiplets can be bonded to a base die 1610 and configured to communicate with each other and logic within the base die 1610 via an interconnect layer 1612. In some examples, the base die 1610 can include global logic 1601, which can include scheduler 1611 and power management 1621 logic units, an interface 1602, a dispatch unit 1603, and an interconnect fabric 1608 coupled with or integrated with one or more L3 cache banks 1609A-1609N. The interconnect fabric 1608 can be an inter-chiplet fabric that is integrated into the base die 1610. Logic chiplets can use the fabric 1608 to relay messages between the various chiplets. Additionally, L3 cache banks 1609A-1609N in the base die and/or L3 cache banks within the memory chiplets 1606 can cache data read from and transmitted to DRAM chiplets within the memory chiplets 1606 and to system memory of a host.

In some examples the global logic 1601 is a microcontroller that can execute firmware to perform scheduler 1611 and power management 1621 functionality for the parallel processor 1620. The microcontroller that executes the global logic can be tailored for the target use case of the parallel processor 1620. The scheduler 1611 can perform global scheduling operations for the parallel processor 1620. The power management 1621 functionality can be used to enable or disable individual chiplets within the parallel processor when those chiplets are not in use.

The various chiplets of the parallel processor 1620 can be designed to perform specific functionality that, in existing designs, would be integrated into a single die. A set of compute chiplets 1605 can include clusters of compute units (e.g., execution units, streaming multiprocessors, etc.) that include programmable logic to execute compute or graphics shader instructions. A media chiplet 1604 can include hardware logic to accelerate media encode and decode operations. Memory chiplets 1606 can include volatile memory (e.g., DRAM) and one or more SRAM cache memory banks (e.g., L3 banks).

As shown in FIG. 16B, each chiplet 1630 can include common components and application specific components. Chiplet logic 1636 within the chiplet 1630 can include the specific components of the chiplet, such as an array of streaming multiprocessors, compute units, or execution units described herein. The chiplet logic 1636 can couple with an optional cache or shared local memory 1638 or can include a cache or shared local memory within the chiplet logic 1636. The chiplet 1630 can include a fabric interconnect node 1642 that receives commands via the inter-chiplet fabric. Commands and data received via the fabric interconnect node 1642 can be stored temporarily within an interconnect buffer 1639. Data transmitted to and received from the fabric interconnect node 1642 can be stored in an interconnect cache 1640. Power control 1632 and clock control 1634 logic can also be included within the chiplet. The power control 1632 and clock control 1634 logic can receive configuration commands via the fabric can configure dynamic voltage and frequency scaling for the chiplet 1630. In some examples, each chiplet can have an independent clock domain and power domain and can be clock gated and power gated independently of other chiplets.

At least a portion of the components within the illustrated chiplet 1630 can also be included within logic embedded within the base die 1610 of FIG. 16A. For example, logic within the base die that communicates with the fabric can include a version of the fabric interconnect node 1642. Base die logic that can be independently clock or power gated can include a version of the power control 1632 and/or clock control 1634 logic.

Thus, while various examples described herein use the term SOC to describe a device or system having a processor and associated circuitry (e.g., Input/Output (“I/O”) circuitry, power delivery circuitry, memory circuitry, etc.) integrated monolithically into a single Integrated Circuit (“IC”) die, or chip, the present disclosure is not limited in that respect. For example, in various examples of the present disclosure, a device or system can have one or more processors (e.g., one or more processor cores) and associated circuitry (e.g., Input/Output (“I/O”) circuitry, power delivery circuitry, etc.) arranged in a disaggregated collection of discrete dies, tiles and/or chiplets (e.g., one or more discrete processor core die arranged adjacent to one or more other die such as memory die, I/O die, etc.). In such disaggregated devices and systems the various dies, tiles and/or chiplets can be physically and electrically coupled together by a package structure including, for example, various packaging substrates, interposers, active interposers, photonic interposers, interconnect bridges and the like. The disaggregated collection of discrete dies, tiles, and/or chiplets can also be part of a System-on-Package (“SoP”).”

### Example Core Architectures—In-Order and Out-of-Order Core Block Diagram

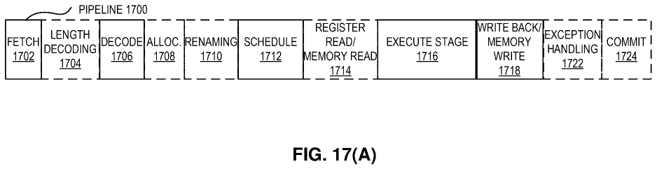

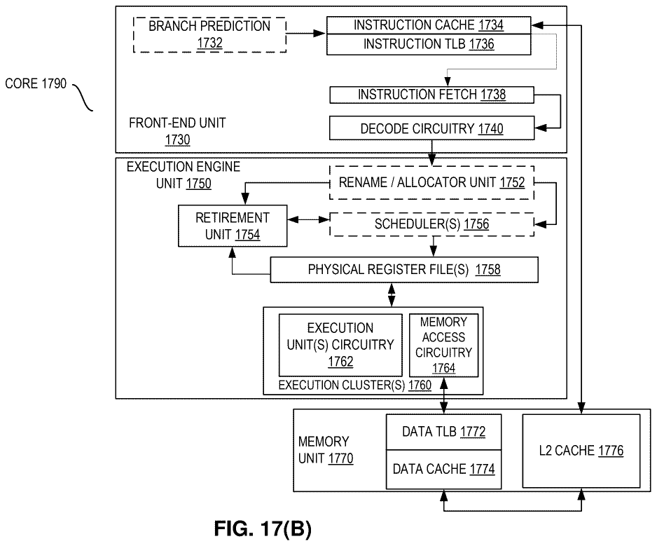

FIG. 17(A) is a block diagram illustrating both an example in-order pipeline and an example register renaming, out-of-order issue/execution pipeline according to examples. FIG. 17(B) is a block diagram illustrating both an example in-order architecture core and an example register renaming, out-of-order issue/execution architecture core to be included in a processor according to examples. The solid lined boxes in FIG. 17(A)-(B) illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 17(A), a processor pipeline 1700 includes a fetch stage 1702, an optional length decoding stage 1704, a decode stage 1706, an optional allocation (Alloc) stage 1708, an optional renaming stage 1710, a schedule (also known as a dispatch or issue) stage 1712, an optional register read/memory read stage 1714, an execute stage 1716, a write back/memory write stage 1718, an optional exception handling stage 1722, and an optional commit stage 1724. One or more operations can be performed in each of these processor pipeline stages. For example, during the fetch stage 1702, one or more instructions are fetched from instruction memory, and during the decode stage 1706, the one or more fetched instructions may be decoded, addresses (e.g., load store unit (LSU) addresses) using forwarded register ports may be generated, and branch forwarding (e.g., immediate offset or a link register (LR)) may be performed. In some examples, the decode stage 1706 and the register read/memory read stage 1714 may be combined into one pipeline stage. In some examples, during the execute stage 1716, the decoded instructions may be executed, LSU address/data pipelining to an Advanced Microcontroller Bus (AMB) interface may be performed, multiply and add operations may be performed, arithmetic operations with branch results may be performed, etc.

By way of example, the example register renaming, out-of-order issue/execution architecture core of FIG. 17(B) may implement the pipeline 1700 as follows: 1) the instruction fetch circuitry 1738 performs the fetch and length decoding stages 1702 and 1704; 2) the decode circuitry 1740 performs the decode stage 1706; 3) the rename/allocator unit circuitry 1752 performs the allocation stage 1708 and renaming stage 1710; 4) the scheduler(s) circuitry 1756 performs the schedule stage 1712; 5) the physical register file(s) circuitry 1758 and the memory unit circuitry 1770 perform the register read/memory read stage 1714; the execution cluster(s) 1760 perform the execute stage 1716; 6) the memory unit circuitry 1770 and the physical register file(s) circuitry 1758 perform the write back/memory write stage 1718; 7) various circuitry may be involved in the exception handling stage 1722; and 8) the retirement unit circuitry 1754 and the physical register file(s) circuitry 1758 perform the commit stage 1724.

FIG. 17(B) shows a processor core 1790 including front-end unit circuitry 1730 coupled to execution engine unit circuitry 1750, and both are coupled to memory unit circuitry 1770. The core 1790 may be a reduced instruction set architecture computing (RISC) core, a complex instruction set architecture computing (CISC) core, a very long instruction word (VLIW) core, or a hybrid or alternative core type. As yet another option, the core 1790 may be a special-purpose core, such as, for example, a network or communication core, compression engine, co-processor core, general purpose computing graphics processing unit (GPGPU) core, graphics core, or the like.

The front-end unit circuitry 1730 may include branch prediction circuitry 1732 coupled to instruction cache circuitry 1734, which is coupled to an instruction translation lookaside buffer (TLB) 1736, which is coupled to instruction fetch circuitry 1738, which is coupled to decode circuitry 1740. In some examples, the instruction cache circuitry 1734 is included in the memory unit circuitry 1770 rather than the front-end unit circuitry 1730. The decode circuitry 1740 (or decoder) may decode instructions, and generate as an output one or more micro-operations, micro-code entry points, microinstructions, other instructions, or other control signals, which are decoded from, or which otherwise reflect, or are derived from, the original instructions. The decode circuitry 1740 may further include address generation unit (AGU, not shown) circuitry. In some examples, the AGU generates an LSU address using forwarded register ports, and may further perform branch forwarding (e.g., immediate offset branch forwarding, LR register branch forwarding, etc.). The decode circuitry 1740 may be implemented using various different mechanisms. Examples of suitable mechanisms include, but are not limited to, look-up tables, hardware implementations, programmable logic arrays (PLAs), microcode read only memories (ROMs), etc. In some examples, the core 1790 includes a microcode ROM (not shown) or other medium that stores microcode for certain macroinstructions (e.g., in decode circuitry 1740 or otherwise within the front-end unit circuitry 1730). In some examples, the decode circuitry 1740 includes a micro-operation (micro-op) or operation cache (not shown) to hold/cache decoded operations, micro-tags, or micro-operations generated during the decode or other stages of the processor pipeline 1700. The decode circuitry 1740 may be coupled to rename/allocator unit circuitry 1752 in the execution engine unit circuitry 1750.

The execution engine unit circuitry 1750 includes the rename/allocator unit circuitry 1752 coupled to retirement unit circuitry 1754 and a set of one or more scheduler(s) circuitry 1756. The scheduler(s) circuitry 1756 represents any number of different schedulers, including reservations stations, central instruction window, etc. In some examples, the scheduler(s) circuitry 1756 can include arithmetic logic unit (ALU) scheduler/scheduling circuitry, ALU queues, address generation unit (AGU) scheduler/scheduling circuitry, AGU queues, etc. The scheduler(s) circuitry 1756 is coupled to the physical register file(s) circuitry 1758. Each of the physical register file(s) circuitry 1758 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In some examples, the physical register file(s) circuitry 1758 includes vector registers unit circuitry, writemask registers unit circuitry, and scalar register unit circuitry. These register units may provide architectural vector registers, vector mask registers, general-purpose registers, etc. The physical register file(s) circuitry 1758 is coupled to the retirement unit circuitry 1754 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 1754 and the physical register file(s) circuitry 1758 are coupled to the execution cluster(s) 1760. The execution cluster(s) 1760 includes a set of one or more execution unit(s) circuitry 1762 and a set of one or more memory access circuitry 1764. The execution unit(s) circuitry 1762 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). In some examples, execution unit(s) circuitry 1762 may include hardware to support functionality for instructions for one or more of a compression engine, graphics processing, neural-network processing, in-memory analytics, matrix operations, cryptographic operations, data streaming operations, data graph operations, etc.

While some examples may include a number of execution units or execution unit circuitry dedicated to specific functions or sets of functions, other examples may include only one execution unit circuitry or multiple execution units/execution unit circuitry that all perform all functions. The scheduler(s) circuitry 1756, physical register file(s) circuitry 1758, and execution cluster(s) 1760 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster- and in the case of a separate memory access pipeline, certain examples are implemented in which only the execution cluster of this pipeline has the memory access unit(s) circuitry 1764). It should also be understood that where separate pipelines are used, one or more of these pipelines may be out-of-order issue/execution and the rest in-order.

In some examples, the execution engine unit circuitry 1750 may perform load store unit (LSU) address/data pipelining to an Advanced Microcontroller Bus (AMB) interface (not shown), and address phase and writeback, data phase load, store, and branches.

The set of memory access circuitry 1764 is coupled to the memory unit circuitry 1770, which includes data TLB circuitry 1772 coupled to data cache circuitry 1774 coupled to level 2 (L2) cache circuitry 1776. In some examples, the memory access circuitry 1764 may include load unit circuitry, store address unit circuitry, and store data unit circuitry, each of which is coupled to the data TLB circuitry 1772 in the memory unit circuitry 1770. The instruction cache circuitry 1734 is further coupled to the level 2 (L2) cache circuitry 1776 in the memory unit circuitry 1770. In some examples, the instruction cache 1734 and the data cache 1774 are combined into a single instruction and data cache (not shown) in L2 cache circuitry 1776, level 3 (L3) cache circuitry (not shown), and/or main memory. The L2 cache circuitry 1776 is coupled to one or more other levels of cache and eventually to a main memory.

The core 1790 may support one or more instructions sets (e.g., the x86 instruction set architecture (optionally with some extensions that have been added with newer versions); the MIPS instruction set architecture; the ARM instruction set architecture (optionally with optional additional extensions such as NEON, etc.); RISC instruction set architecture), including the instruction(s) described herein. In some examples, the core 1790 includes logic to support a packed data instruction set architecture extension (e.g., AVX1, AVX2, AVX512, AMX, etc.), thereby allowing the operations used by many multimedia applications to be performed using packed data. Example Execution Unit(s) Circuitry.

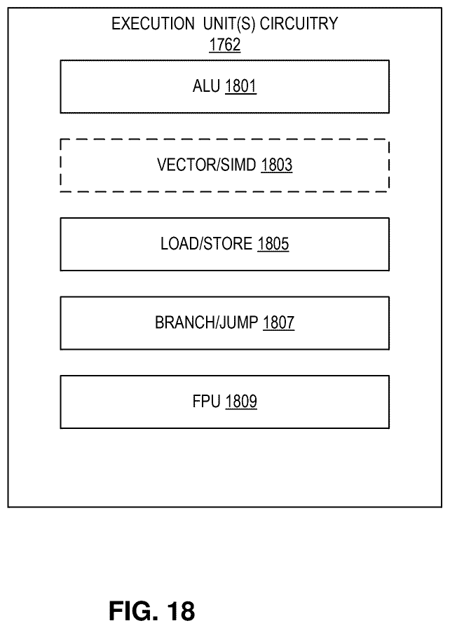

FIG. 18 illustrates examples of execution unit(s) circuitry, such as execution unit(s) circuitry 1762 of FIG. 17(B). As illustrated, execution unit(s) circuitry 1762 may include one or more ALU circuits 1801, optional vector/single instruction multiple data (SIMD) circuits 1803, load/store circuits 1805, branch/jump circuits 1807, and/or Floating-point unit (FPU) circuits 1809. ALU circuits 1801 perform integer arithmetic and/or Boolean operations. Vector/SIMD circuits 1803 perform vector/SIMD operations on packed data (such as SIMD/vector registers). Load/store circuits 1805 execute load and store instructions to load data from memory into registers or store from registers to memory. Load/store circuits 1805 may also generate addresses. Branch/jump circuits 1807 cause a branch or jump to a memory address depending on the instruction. FPU circuits 1809 perform floating-point arithmetic. The width of the execution unit(s) circuitry 1762 varies depending upon the example and can range from 16-bit to 1,024-bit, for example. In some examples, two or more smaller execution units are logically combined to form a larger execution unit (e.g., two 128-bit execution units are logically combined to form a 256-bit execution unit).

### Example Register Architecture

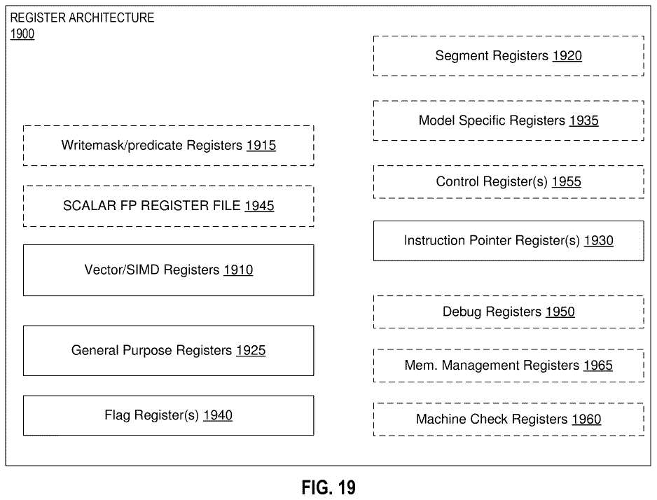

FIG. 19 is a block diagram of a register architecture 1900 according to some examples. As illustrated, the register architecture 1900 includes vector/SIMD registers 1910 that vary from 128-bit to 1,024 bits width. In some examples, the vector/SIMD registers 1910 are physically 512-bits and, depending upon the mapping, only some of the lower bits are used. For example, in some examples, the vector/SIMD registers 1910 are ZMM registers which are 512 bits: the lower 256 bits are used for YMM registers and the lower 128 bits are used for XMM registers. As such, there is an overlay of registers. In some examples, a vector length field selects between a maximum length and one or more other shorter lengths, where each such shorter length is half the length of the preceding length. Scalar operations are operations performed on the lowest order data element position in a ZMM/YMM/XMM register; the higher order data element positions are either left the same as they were prior to the instruction or zeroed depending on the example.

In some examples, the register architecture 1900 includes writemask/predicate registers 1915. For example, in some examples, there are 8 writemask/predicate registers (sometimes called k0 through k7) that are each 16-bit, 32-bit, 64-bit, or 128-bit in size. Writemask/predicate registers 1915 may allow for merging (e.g., allowing any set of elements in the destination to be protected from updates during the execution of any operation) and/or zeroing (e.g., zeroing vector masks allow any set of elements in the destination to be zeroed during the execution of any operation). In some examples, each data element position in a given writemask/predicate register 1915 corresponds to a data element position of the destination. In other examples, the writemask/predicate registers 1915 are scalable and consists of a set number of enable bits for a given vector element (e.g., 8 enable bits per 64-bit vector element).

The register architecture 1900 includes a plurality of general-purpose registers 1925. These registers may be 16-bit, 32-bit, 64-bit, etc. and can be used for scalar operations. In some examples, these registers are referenced by the names RAX, RBX, RCX, RDX, RBP, RSI, RDI, RSP, and R8 through R15.

In some examples, the register architecture 1900 includes scalar floating-point (FP) register file 1945 which is used for scalar floating-point operations on 32/64/80-bit floating-point data using the x87 instruction set architecture extension or as MMX registers to perform operations on 64-bit packed integer data, as well as to hold operands for some operations performed between the MMX and XMM registers.

One or more flag registers 1940 (e.g., EFLAGS, RFLAGS, etc.) store status and control information for arithmetic, compare, and system operations. For example, the one or more flag registers 1940 may store condition code information such as carry, parity, auxiliary carry, zero, sign, and overflow. In some examples, the one or more flag registers 1940 are called program status and control registers.

Segment registers 1920 contain segment points for use in accessing memory. In some examples, these registers are referenced by the names CS, DS, SS, ES, FS, and GS.

Model specific registers or machine specific registers (MSRs) 1935 control and report on processor performance. Most MSRs 1935 handle system-related functions and are not accessible to an application program. For example, MSRs may provide control for one or more of: performance-monitoring counters, debug extensions, memory type range registers, thermal and power management, instruction-specific support, and/or processor feature/mode support. Machine check registers 1960 consist of control, status, and error reporting MSRs that are used to detect and report on hardware errors. Control register(s) 1955 (e.g., CR0-CR4) determine the operating mode of a processor (e.g., processor 1070, 1080, 1038, 1015, and/or 1100) and the characteristics of a currently executing task. In some examples, MSRs 1935 are a subset of control registers 1955.

One or more instruction pointer register(s) 1930 store an instruction pointer value. Debug registers 1950 control and allow for the monitoring of a processor or core's debugging operations.

Memory (mem) management registers 1965 specify the locations of data structures used in protected mode memory management. These registers may include a global descriptor table register (GDTR), interrupt descriptor table register (IDTR), task register, and a local descriptor table register (LDTR) register.

Alternative examples may use wider or narrower registers. Additionally, alternative examples may use more, less, or different register files and registers. The register architecture 1900 may, for example, be used in register file/memory ISAB08, or physical register file(s) circuitry 1758.

### Graphics Execution Units

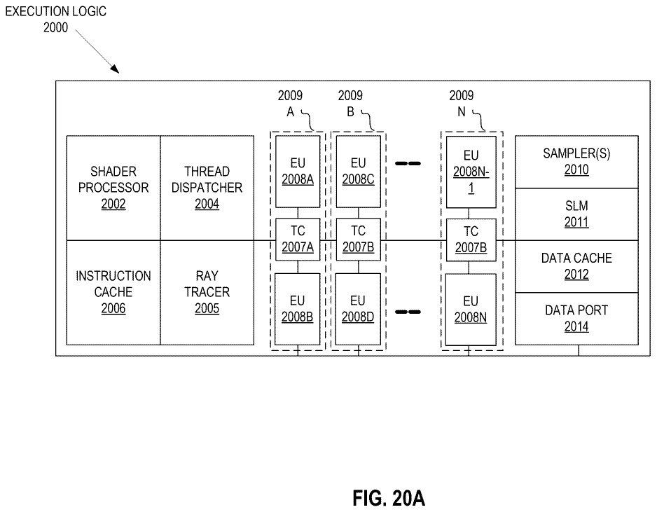

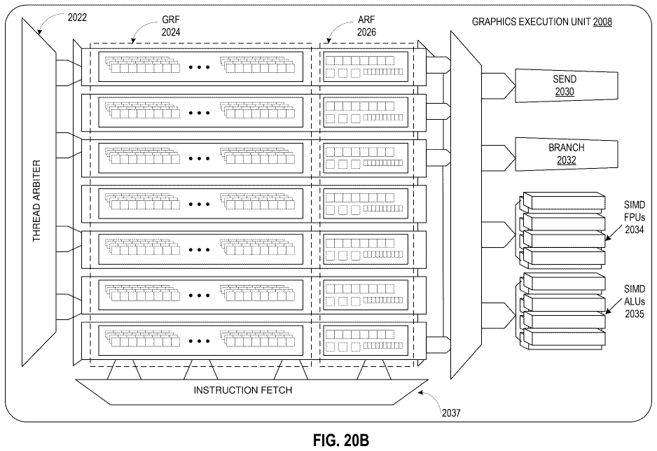

FIGS. 20A-20B illustrate thread execution logic 2000 including an array of processing elements employed in a graphics processor core according to examples described herein. Elements of FIGS. 20A-20B having the same reference numbers (or names) as the elements of any other figure herein can operate or function in any manner similar to that described elsewhere herein, but are not limited to such. FIG. 20A is representative of an execution unit within a general-purpose graphics processor, while FIG. 20B is representative of an execution unit that may be used within a compute accelerator.

As illustrated in FIG. 20A, in some examples thread execution logic 2000 includes a shader processor 2002, a thread dispatcher 2004, instruction cache 2006, a scalable execution unit array including a plurality of execution units 2008A-2008N, a sampler 2010, shared local memory 2011, a data cache 2012, and a data port 2014. In some examples the scalable execution unit array can dynamically scale by enabling or disabling one or more execution units (e.g., any of execution units 2008A, 2008B, 2008C, 2008D, through 2008N-1 and 2008N) based on the computational requirements of a workload. In some examples the included components are interconnected via an interconnect fabric that links to each of the components. In some examples, thread execution logic 2000 includes one or more connections to memory, such as system memory or cache memory, through one or more of instruction cache 2006, data port 2014, sampler 2010, and execution units 2008A-2008N. In some examples, each execution unit (e.g. 2008A) is a stand-alone programmable general-purpose computational unit that is capable of executing multiple simultaneous hardware threads while processing multiple data elements in parallel for each thread. In various examples, the array of execution units 2008A-2008N is scalable to include any number individual execution units.

In some examples, the execution units 2008A-2008N are primarily used to execute shader programs. A shader processor 2002 can process the various shader programs and dispatch execution threads associated with the shader programs via a thread dispatcher 2004. In some examples the thread dispatcher includes logic to arbitrate thread initiation requests from the graphics and media pipelines and instantiate the requested threads on one or more execution unit in the execution units 2008A-2008N. For example, a geometry pipeline can dispatch vertex, tessellation, or geometry shaders to the thread execution logic for processing. In some examples, thread dispatcher 2004 can also process runtime thread spawning requests from the executing shader programs.

In some examples, the execution units 2008A-2008N support an instruction set that includes native support for many standard 3D graphics shader instructions, such that shader programs from graphics libraries (e.g., Direct 3D and OpenGL) are executed with a minimal translation. The execution units support vertex and geometry processing (e.g., vertex programs, geometry programs, vertex shaders), pixel processing (e.g., pixel shaders, fragment shaders) and general-purpose processing (e.g., compute and media shaders). Each of the execution units 2008A-2008N is capable of multi-issue single instruction multiple data (SIMD) execution and multi-threaded operation enables an efficient execution environment in the face of higher latency memory accesses. Each hardware thread within each execution unit has a dedicated high-bandwidth register file and associated independent thread-state. Execution is multi-issue per clock to pipelines capable of integer, single and double precision floating point operations, SIMD branch capability, logical operations, transcendental operations, and other miscellaneous operations. While waiting for data from memory or one of the shared functions, dependency logic within the execution units 2008A-2008N causes a waiting thread to sleep until the requested data has been returned. While the waiting thread is sleeping, hardware resources may be devoted to processing other threads. For example, during a delay associated with a vertex shader operation, an execution unit can perform operations for a pixel shader, fragment shader, or another type of shader program, including a different vertex shader. Various examples can apply to use execution by use of Single Instruction Multiple Thread (SIMT) as an alternate to use of SIMD or in addition to use of SIMD. Reference to a SIMD core or operation can apply also to SIMT or apply to SIMD in combination with SIMT.

Each execution unit in execution units 2008A-2008N operates on arrays of data elements. The number of data elements is the “execution size,” or the number of channels for the instruction. An execution channel is a logical unit of execution for data element access, masking, and flow control within instructions. The number of channels may be independent of the number of physical Arithmetic Logic Units (ALUs) or Floating Point Units (FPUs) for a particular graphics processor. In some examples, execution units 2008A-2008N support integer and floating-point data types.

The execution unit instruction set includes SIMD instructions. The various data elements can be stored as a packed data type in a register and the execution unit will process the various elements based on the data size of the elements. For example, when operating on a 256-bit wide vector, the 256 bits of the vector are stored in a register and the execution unit operates on the vector as four separate 64-bit packed data elements (Quad-Word (QW) size data elements), eight separate 32-bit packed data elements (Double Word (DW) size data elements), sixteen separate 16-bit packed data elements (Word (W) size data elements), or thirty-two separate 8-bit data elements (byte (B) size data elements). However, different vector widths and register sizes are possible.

In some examples one or more execution units can be combined into a fused graphics execution unit 2009A-2009N having thread control logic (2007A-2007N) that is common to the fused EUs. Multiple EUs can be fused into an EU group. Each EU in the fused EU group can be configured to execute a separate SIMD hardware thread. The number of EUs in a fused EU group can vary according to examples. Additionally, various SIMD widths can be performed per-EU, including but not limited to SIMD8, SIMD16, and SIMD32. Each fused graphics execution unit 2009A-2009N includes at least two execution units. For example, fused execution unit 2009A includes a first EU 2008A, second EU 2008B, and thread control logic 2007A that is common to the first EU 2008A and the second EU 2008B. The thread control logic 2007A controls threads executed on the fused graphics execution unit 2009A, allowing each EU within the fused execution units 2009A-2009N to execute using a common instruction pointer register.

One or more internal instruction caches (e.g., 2006) are included in the thread execution logic 2000 to cache thread instructions for the execution units. In some examples, one or more data caches (e.g., 2012) are included to cache thread data during thread execution. Threads executing on the thread execution logic 2000 can also store explicitly managed data in the shared local memory 2011. In some examples, a sampler 2010 is included to provide texture sampling for 3D operations and media sampling for media operations. In some examples, sampler 2010 includes specialized texture or media sampling functionality to process texture or media data during the sampling process before providing the sampled data to an execution unit.

During execution, the graphics and media pipelines send thread initiation requests to thread execution logic 2000 via thread spawning and dispatch logic. Once a group of geometric objects has been processed and rasterized into pixel data, pixel processor logic (e.g., pixel shader logic, fragment shader logic, etc.) within the shader processor 2002 is invoked to further compute output information and cause results to be written to output surfaces (e.g., color buffers, depth buffers, stencil buffers, etc.). In some examples, a pixel shader or fragment shader calculates the values of the various vertex attributes that are to be interpolated across the rasterized object. In some examples, pixel processor logic within the shader processor 2002 then executes an application programming interface (API)-supplied pixel or fragment shader program. To execute the shader program, the shader processor 2002 dispatches threads to an execution unit (e.g., 2008A) via thread dispatcher 2004. In some examples, shader processor 2002 uses texture sampling logic in the sampler 2010 to access texture data in texture maps stored in memory. Arithmetic operations on the texture data and the input geometry data compute pixel color data for each geometric fragment, or discards one or more pixels from further processing.

In some examples, the data port 2014 provides a memory access mechanism for the thread execution logic 2000 to output processed data to memory for further processing on a graphics processor output pipeline. In some examples, the data port 2014 includes or couples to one or more cache memories (e.g., data cache 2012) to cache data for memory access via the data port.

In some examples, the execution logic 2000 can also include a ray tracer 2005 that can provide ray tracing acceleration functionality. The ray tracer 2005 can support a ray tracing instruction set that includes instructions/functions for ray generation.

FIG. 20B illustrates exemplary internal details of an execution unit 2008, according to examples. A graphics execution unit 2008 can include an instruction fetch unit 2037, a general register file array (GRF) 2024, an architectural register file array (ARF) 2026, a thread arbiter 2022, a send unit 2030, a branch unit 2032, a set of SIMD floating point units (FPUs) 2034, and in some examples a set of dedicated integer SIMD ALUs 2035. The GRF 2024 and ARF 2026 includes the set of general register files and architecture register files associated with each simultaneous hardware thread that may be active in the graphics execution unit 2008. In some examples, per thread architectural state is maintained in the ARF 2026, while data used during thread execution is stored in the GRF 2024. The execution state of each thread, including the instruction pointers for each thread, can be held in thread-specific registers in the ARF 2026.

In some examples the graphics execution unit 2008 has an architecture that is a combination of Simultaneous Multi-Threading (SMT) and fine-grained Interleaved Multi-Threading (IMT). The architecture has a modular configuration that can be fine-tuned at design time based on a target number of simultaneous threads and number of registers per execution unit, where execution unit resources are divided across logic used to execute multiple simultaneous threads. The number of logical threads that may be executed by the graphics execution unit 2008 is not limited to the number of hardware threads, and multiple logical threads can be assigned to each hardware thread.

In some examples, the graphics execution unit 2008 can co-issue multiple instructions, which may each be different instructions. The thread arbiter 2022 of the graphics execution unit thread 2008 can dispatch the instructions to one of the send unit 2030, branch unit 2032, or SIMD FPU(s) 2034 for execution. Each execution thread can access 128 general-purpose registers within the GRF 2024, where each register can store 32 bytes, accessible as a SIMD 8-element vector of 32-bit data elements. In some examples, each execution unit thread has access to 4 Kbytes within the GRF 2024, although examples are not so limited, and greater or fewer register resources may be provided in other examples. In some examples the graphics execution unit 2008 is partitioned into seven hardware threads that can independently perform computational operations, although the number of threads per execution unit can also vary according to examples. For example, in some examples up to 16 hardware threads are supported. In an example in which seven threads may access 4 Kbytes, the GRF 2024 can store a total of 28 Kbytes. Where 16 threads may access 4 Kbytes, the GRF 2024 can store a total of 64 Kbytes. Flexible addressing modes can permit registers to be addressed together to build effectively wider registers or to represent strided rectangular block data structures.

In some examples, memory operations, sampler operations, and other longer-latency system communications are dispatched via “send” instructions that are executed by the message passing send unit 2030. In some examples, branch instructions are dispatched to a dedicated branch unit 2032 to facilitate SIMD divergence and eventual convergence.

In some examples the graphics execution unit 2008 includes one or more SIMD FPU(s) 2034 to perform floating-point operations. In some examples, the FPU(s) 2034 also support integer computation. In some examples the FPU(s) 2034 can SIMD execute up to M number of 32-bit floating-point (or integer) operations, or SIMD execute up to 2 M 16-bit integer or 16-bit floating-point operations. In some examples, at least one of the FPU(s) provides extended math capability to support high-throughput transcendental math functions and double precision 64-bit floating-point. In some examples, a set of 8-bit integer SIMD ALUs 2035 are also present, and may be specifically optimized to perform operations associated with machine learning computations.

In some examples, arrays of multiple instances of the graphics execution unit 2008 can be instantiated in a graphics sub-core grouping (e.g., a sub-slice). For scalability, product architects can choose the exact number of execution units per sub-core grouping. In some examples the execution unit 2008 can execute instructions across a plurality of execution channels. In a further example, each thread executed on the graphics execution unit 2008 is executed on a different channel.

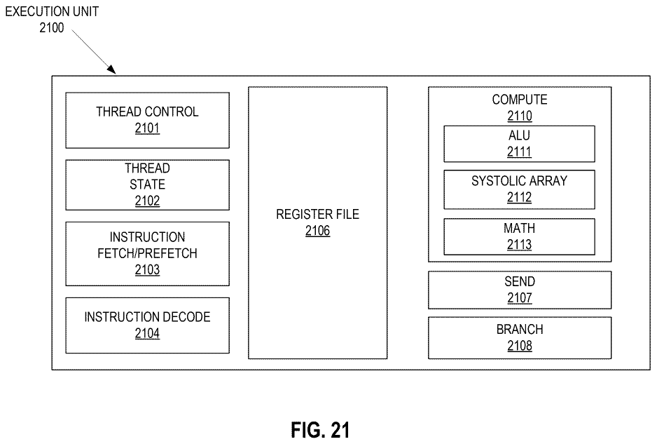

FIG. 21 illustrates an additional execution unit 2100, according to an example. In some examples, the execution unit 2100 includes a thread control unit 2101, a thread state unit 2102, an instruction fetch/prefetch unit 2103, and an instruction decode unit 2104. The execution unit 2100 additionally includes a register file 2106 that stores registers that can be assigned to hardware threads within the execution unit. The execution unit 2100 additionally includes a send unit 2107 and a branch unit 2108. In some examples, the send unit 2107 and branch unit 2108 can operate similarly as the send unit 2030 and a branch unit 2032 of the graphics execution unit 2008 of FIG. 20B.

The execution unit 2100 also includes a compute unit 2110 that includes multiple different types of functional units. In some examples the compute unit 2110 includes an ALU unit 2111 that includes an array of arithmetic logic units. The ALU unit 2111 can be configured to perform 64-bit, 32-bit, and 16-bit integer and floating point operations. Integer and floating point operations may be performed simultaneously. The compute unit 2110 can also include a systolic array 2112, and a math unit 2113. The systolic array 2112 includes a W wide and D deep network of data processing units that can be used to perform vector or other data-parallel operations in a systolic manner. In some examples the systolic array 2112 can be configured to perform matrix operations, such as matrix dot product operations. In some examples the systolic array 2112 support 16-bit floating point operations, as well as 8-bit and 4-bit integer operations. In some examples the systolic array 2112 can be configured to accelerate machine learning operations. In such examples, the systolic array 2112 can be configured with support for the bfloat 16-bit floating point format. In some examples, a math unit 2113 can be included to perform a specific subset of mathematical operations in an efficient and lower-power manner than the ALU unit 2111. The math unit 2113 can include a variant of math logic that may be found in shared function logic of a graphics processing engine provided by other examples. In some examples the math unit 2113 can be configured to perform 32-bit and 64-bit floating point operations.

The thread control unit 2101 includes logic to control the execution of threads within the execution unit. The thread control unit 2101 can include thread arbitration logic to start, stop, and preempt execution of threads within the execution unit 2100. The thread state unit 2102 can be used to store thread state for threads assigned to execute on the execution unit 2100. Storing the thread state within the execution unit 2100 enables the rapid pre-emption of threads when those threads become blocked or idle. The instruction fetch/prefetch unit 2103 can fetch instructions from an instruction cache of higher level execution logic (e.g., instruction cache 2006 as in FIG. 20A). The instruction fetch/prefetch unit 2103 can also issue prefetch requests for instructions to be loaded into the instruction cache based on an analysis of currently executing threads. The instruction decode unit 2104 can be used to decode instructions to be executed by the compute units. In some examples, the instruction decode unit 2104 can be used as a secondary decoder to decode complex instructions into constituent micro-operations.

The execution unit 2100 additionally includes a register file 2106 that can be used by hardware threads executing on the execution unit 2100. Registers in the register file 2106 can be divided across the logic used to execute multiple simultaneous threads within the compute unit 2110 of the execution unit 2100. The number of logical threads that may be executed by the execution unit 2100 is not limited to the number of hardware threads, and multiple logical threads can be assigned to each hardware thread. The size of the register file 2106 can vary across examples based on the number of supported hardware threads. In some examples, register renaming may be used to dynamically allocate registers to hardware threads.

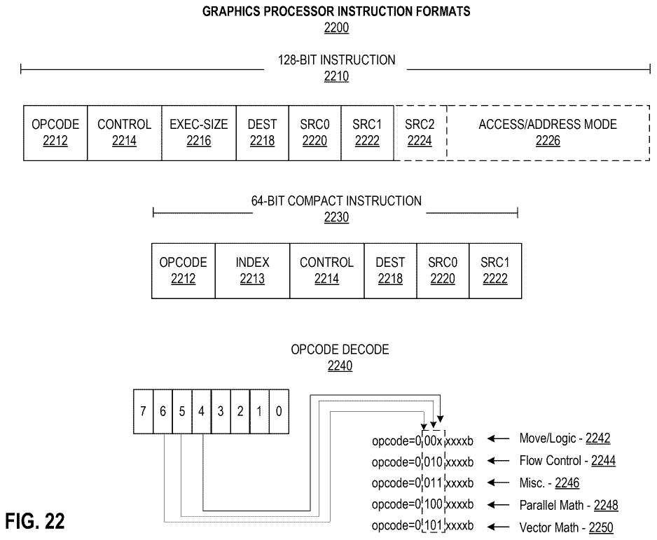

FIG. 22 is a block diagram illustrating a graphics processor instruction formats 2200 according to some examples. In one or more example, the graphics processor execution units support an instruction set having instructions in multiple formats. The solid lined boxes illustrate the components that are generally included in an execution unit instruction, while the dashed lines include components that are optional or that are only included in a sub-set of the instructions. In some examples, instruction format 2200 described and illustrated are macro-instructions, in that they are instructions supplied to the execution unit, as opposed to micro-operations resulting from instruction decode once the instruction is processed.

In some examples, the graphics processor execution units natively support instructions in a 128-bit instruction format 2210. A 64-bit compacted instruction format 2230 is available for some instructions based on the selected instruction, instruction options, and number of operands. The native 128-bit instruction format 2210 provides access to all instruction options, while some options and operations are restricted in the 64-bit compacted format 2230. The native instructions available in the 64-bit compacted format 2230 vary by example. In some examples, the instruction is compacted in part using a set of index values in an index field 2213. The execution unit hardware references a set of compaction tables based on the index values and uses the compaction table outputs to reconstruct a native instruction in the 128-bit instruction format 2210. Other sizes and formats of instruction can be used.

For each format, instruction opcode 2212 defines the operation that the execution unit is to perform. The execution units execute each instruction in parallel across the multiple data elements of each operand. For example, in response to an add instruction the execution unit performs a simultaneous add operation across each color channel representing a texture element or picture element. By default, the execution unit performs each instruction across all data channels of the operands. In some examples, instruction control field 2214 enables control over certain execution options, such as channels selection (e.g., predication) and data channel order (e.g., swizzle). For instructions in the 128-bit instruction format 2210 an exec-size field 2216 limits the number of data channels that will be executed in parallel. In some examples, exec-size field 2216 is not available for use in the 64-bit compact instruction format 2230.

Some execution unit instructions have up to three operands including two source operands, src0 2220, src1 2222, and one destination 2218. In some examples, the execution units support dual destination instructions, where one of the destinations is implied. Data manipulation instructions can have a third source operand (e.g., SRC2 2224), where the instruction opcode 2212 determines the number of source operands. An instruction's last source operand can be an immediate (e.g., hard-coded) value passed with the instruction.

In some examples, the 128-bit instruction format 2210 includes an access/address mode field 2226 specifying, for example, whether direct register addressing mode or indirect register addressing mode is used. When direct register addressing mode is used, the register address of one or more operands is directly provided by bits in the instruction.

In some examples, the 128-bit instruction format 2210 includes an access/address mode field 2226, which specifies an address mode and/or an access mode for the instruction. In some examples the access mode is used to define a data access alignment for the instruction. Some examples support access modes including a 16-byte aligned access mode and a 1-byte aligned access mode, where the byte alignment of the access mode determines the access alignment of the instruction operands. For example, when in a first mode, the instruction may use byte-aligned addressing for source and destination operands and when in a second mode, the instruction may use 16-byte-aligned addressing for all source and destination operands.

In some examples, the address mode portion of the access/address mode field 2226 determines whether the instruction is to use direct or indirect addressing. When direct register addressing mode is used bits in the instruction directly provide the register address of one or more operands. When indirect register addressing mode is used, the register address of one or more operands may be computed based on an address register value and an address immediate field in the instruction.

In some examples instructions are grouped based on opcode 2212 bit-fields to simplify Opcode decode 2240. For an 8-bit opcode, bits 4, 5, and 6 allow the execution unit to determine the type of opcode. The precise opcode grouping shown is merely an example. In some examples, a move and logic opcode group 2242 includes data movement and logic instructions (e.g., move (mov), compare (cmp)). In some examples, move and logic opcode group 2242 shares the five most significant bits (MSB), where move (mov) instructions are in the form of 0000xxxxb and logic instructions are in the form of 0001xxxxb. A flow control instruction group 2244 (e.g., call, jump (jmp)) includes instructions in the form of 0010xxxxb (e.g., 0x20). A miscellaneous instruction group 2246 includes a mix of instructions, including synchronization instructions (e.g., wait, send) in the form of 0011xxxxb (e.g., 0x30). A parallel math instruction group 2248 includes component-wise arithmetic instructions (e.g., add, multiply (mul)) in the form of 0100xxxxb (e.g., 0x40). The parallel math instruction group 2248 performs the arithmetic operations in parallel across data channels. The vector math group 2250 includes arithmetic instructions (e.g., dp4) in the form of 0101xxxxb (e.g., 0x50). The vector math group performs arithmetic such as dot product calculations on vector operands. The illustrated opcode decode 2240, in some examples, can be used to determine which portion of an execution unit will be used to execute a decoded instruction. For example, some instructions may be designated as systolic instructions that will be performed by a systolic array. Other instructions, such as ray-tracing instructions (not shown) can be routed to a ray-tracing core or ray-tracing logic within a slice or partition of execution logic.

### Graphics Pipeline

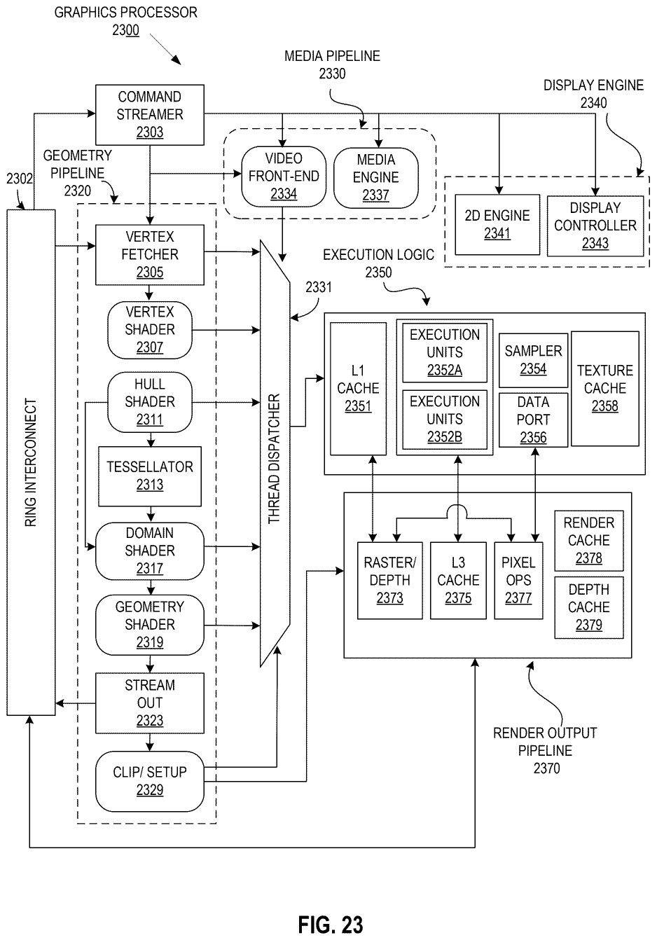

FIG. 23 is a block diagram of another example of a graphics processor 2300. Elements of FIG. 23 having the same reference numbers (or names) as the elements of any other figure herein can operate or function in any manner similar to that described elsewhere herein, but are not limited to such.

In some examples, graphics processor 2300 includes a geometry pipeline 2320, a media pipeline 2330, a display engine 2340, thread execution logic 2350, and a render output pipeline 2370. In some examples, graphics processor 2300 is a graphics processor within a multi-core processing system that includes one or more general-purpose processing cores. The graphics processor is controlled by register writes to one or more control registers (not shown) or via commands issued to graphics processor 2300 via a ring interconnect 2302. In some examples, ring interconnect 2302 couples graphics processor 2300 to other processing components, such as other graphics processors or general-purpose processors. Commands from ring interconnect 2302 are interpreted by a command streamer 2303, which supplies instructions to individual components of the geometry pipeline 2320 or the media pipeline 2330.

In some examples, command streamer 2303 directs the operation of a vertex fetcher 2305 that reads vertex data from memory and executes vertex-processing commands provided by command streamer 2303. In some examples, vertex fetcher 2305 provides vertex data to a vertex shader 2307, which performs coordinate space transformation and lighting operations to each vertex. In some examples, vertex fetcher 2305 and vertex shader 2307 execute vertex-processing instructions by dispatching execution threads to execution units 2352A-2352B via a thread dispatcher 2331.

In some examples, execution units 2352A-2352B are an array of vector processors having an instruction set for performing graphics and media operations. In some examples, execution units 2352A-2352B have an attached L1 cache 2351 that is specific for each array or shared between the arrays. The cache can be configured as a data cache, an instruction cache, or a single cache that is partitioned to contain data and instructions in different partitions.

In some examples, geometry pipeline 2320 includes tessellation components to perform hardware-accelerated tessellation of 3D objects. In some examples, a programmable hull shader 2311 configures the tessellation operations. A programmable domain shader 2317 provides back-end evaluation of tessellation output. A tessellator 2313 operates at the direction of hull shader 2311 and contains special purpose logic to generate a set of detailed geometric objects based on a coarse geometric model that is provided as input to geometry pipeline 2320. In some examples, if tessellation is not used, tessellation components (e.g., hull shader 2311, tessellator 2313, and domain shader 2317) can be bypassed.

In some examples, complete geometric objects can be processed by a geometry shader 2319 via one or more threads dispatched to execution units 2352A-2352B, or can proceed directly to the clipper 2329. In some examples, the geometry shader operates on entire geometric objects, rather than vertices or patches of vertices as in previous stages of the graphics pipeline. If the tessellation is disabled the geometry shader 2319 receives input from the vertex shader 2307. In some examples, geometry shader 2319 is programmable by a geometry shader program to perform geometry tessellation if the tessellation units are disabled.

Before rasterization, a clipper 2329 processes vertex data. The clipper 2329 may be a fixed function clipper or a programmable clipper having clipping and geometry shader functions. In some examples, a rasterizer and depth test component 2373 in the render output pipeline 2370 dispatches pixel shaders to convert the geometric objects into per pixel representations. In some examples, pixel shader logic is included in thread execution logic 2350. In some examples, an application can bypass the rasterizer and depth test component 2373 and access un-rasterized vertex data via a stream out unit 2323.

The graphics processor 2300 has an interconnect bus, interconnect fabric, or some other interconnect mechanism that allows data and message passing amongst the major components of the processor. In some examples, execution units 2352A-2352B and associated logic units (e.g., L1 cache 2351, sampler 2354, texture cache 2358, etc.) interconnect via a data port 2356 to perform memory access and communicate with render output pipeline components of the processor. In some examples, sampler 2354, caches 2351, 2358 and execution units 2352A-2352B each have separate memory access paths. In some examples the texture cache 2358 can also be configured as a sampler cache.

In some examples, render output pipeline 2370 contains a rasterizer and depth test component 2373 that converts vertex-based objects into an associated pixel-based representation. In some examples, the rasterizer logic includes a windower/masker unit to perform fixed function triangle and line rasterization. An associated render cache 2378 and depth cache 2379 are also available in some examples. A pixel operations component 2377 performs pixel-based operations on the data, though in some instances, pixel operations associated with 2D operations (e.g. bit block image transfers with blending) are performed by the 2D engine 2341, or substituted at display time by the display controller 2343 using overlay display planes. In some examples, a shared L3 cache 2375 is available to all graphics components, allowing the sharing of data without the use of main system memory.

In some examples, media pipeline 2330 includes a media engine 2337 and a video front-end 2334. In some examples, video front-end 2334 receives pipeline commands from the command streamer 2303. In some examples, media pipeline 2330 includes a separate command streamer. In some examples, video front-end 2334 processes media commands before sending the command to the media engine 2337. In some examples, media engine 2337 includes thread spawning functionality to spawn threads for dispatch to thread execution logic 2350 via thread dispatcher 2331.

In some examples, graphics processor 2300 includes a display engine 2340. In some examples, display engine 2340 is external to graphics processor 2300 and couples with the graphics processor via the ring interconnect 2302, or some other interconnect bus or fabric. In some examples, display engine 2340 includes a 2D engine 2341 and a display controller 2343. In some examples, display engine 2340 contains special purpose logic capable of operating independently of the 3D pipeline. In some examples, display controller 2343 couples with a display device (not shown), which may be a system integrated display device, as in a laptop computer, or an external display device attached via a display device connector.

In some examples, the geometry pipeline 2320 and media pipeline 2330 are configurable to perform operations based on multiple graphics and media programming interfaces and are not specific to any one application programming interface (API). In some examples, driver software for the graphics processor translates API calls that are specific to a particular graphics or media library into commands that can be processed by the graphics processor. In some examples, support is provided for the Open Graphics Library (OpenGL), Open Computing Language (OpenCL), and/or Vulkan graphics and compute API, all from the Khronos Group. In some examples, support may also be provided for the Direct3D library from the Microsoft Corporation. In some examples, a combination of these libraries may be supported. Support may also be provided for the Open Source Computer Vision Library (OpenCV). A future API with a compatible 3D pipeline would also be supported if a mapping can be made from the pipeline of the future API to the pipeline of the graphics processor.

### Graphics Pipeline Programming

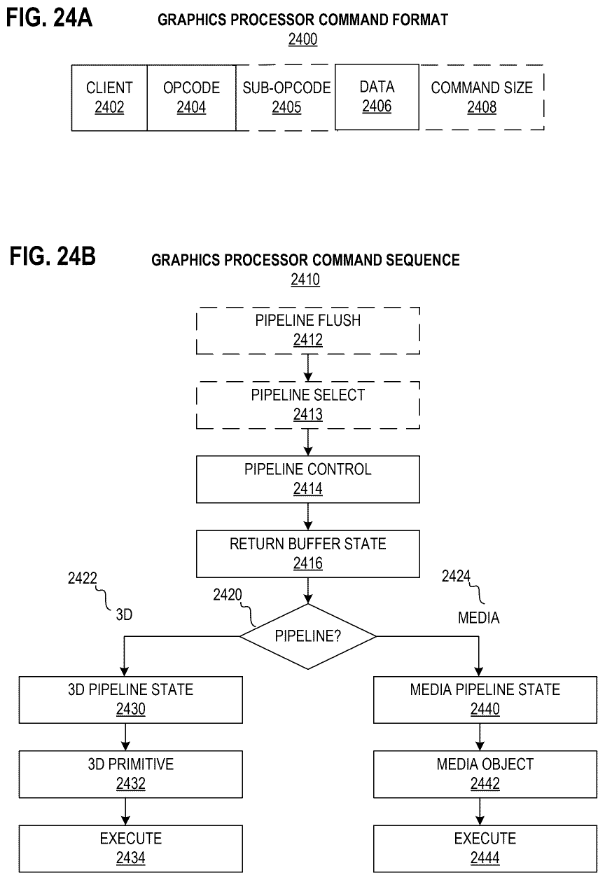

FIG. 24A is a block diagram illustrating a graphics processor command format 2400 according to some examples. FIG. 24B is a block diagram illustrating a graphics processor command sequence 2410 according to an example. The solid lined boxes in FIG. 24A illustrate the components that are generally included in a graphics command while the dashed lines include components that are optional or that are only included in a sub-set of the graphics commands. The graphics processor command format 2400 of FIG. 24A includes data fields to identify a client 2402, a command operation code (opcode) 2404, and data 2406 for the command. A sub-opcode 2405 and a command size 2408 are also included in some commands.

In some examples, client 2402 specifies the client unit of the graphics device that processes the command data. In some examples, a graphics processor command parser examines the client field of each command to condition the further processing of the command and route the command data to the appropriate client unit. In some examples, the graphics processor client units include a memory interface unit, a render unit, a 2D unit, a 3D unit, and a media unit. Each client unit has a corresponding processing pipeline that processes the commands. Once the command is received by the client unit, the client unit reads the opcode 2404 and, if present, sub-opcode 2405 to determine the operation to perform. The client unit performs the command using information in data field 2406. For some commands an explicit command size 2408 is expected to specify the size of the command. In some examples, the command parser automatically determines the size of at least some of the commands based on the command opcode. In some examples commands are aligned via multiples of a double word. Other command formats can be used.

The flow diagram in FIG. 24B illustrates a graphics processor command sequence 2410. In some examples, software or firmware of a data processing system that features an example of a graphics processor uses a version of the command sequence shown to set up, execute, and terminate a set of graphics operations. A sample command sequence is shown and described for purposes of example only as examples are not limited to these specific commands or to this command sequence. Moreover, the commands may be issued as batch of commands in a command sequence, such that the graphics processor will process the sequence of commands in at least partially concurrence.

In some examples, the graphics processor command sequence 2410 may begin with a pipeline flush command 2412 to cause any active graphics pipeline to complete the currently pending commands for the pipeline. In some examples, the 3D pipeline 2422 and the media pipeline 2424 do not operate concurrently. The pipeline flush is performed to cause the active graphics pipeline to complete any pending commands. In response to a pipeline flush, the command parser for the graphics processor will pause command processing until the active drawing engines complete pending operations and the relevant read caches are invalidated. Optionally, any data in the render cache that is marked ‘dirty’ can be flushed to memory. In some examples, pipeline flush command 2412 can be used for pipeline synchronization or before placing the graphics processor into a low power state.

In some examples, a pipeline select command 2413 is used when a command sequence requires the graphics processor to explicitly switch between pipelines. In some examples, a pipeline select command 2413 is required only once within an execution context before issuing pipeline commands unless the context is to issue commands for both pipelines. In some examples, a pipeline flush command 2412 is required immediately before a pipeline switch via the pipeline select command 2413.

In some examples, a pipeline control command 2414 configures a graphics pipeline for operation and is used to program the 3D pipeline 2422 and the media pipeline 2424. In some examples, pipeline control command 2414 configures the pipeline state for the active pipeline. In some examples, the pipeline control command 2414 is used for pipeline synchronization and to clear data from one or more cache memories within the active pipeline before processing a batch of commands.

In some examples, return buffer state commands 2416 are used to configure a set of return buffers for the respective pipelines to write data. Some pipeline operations require the allocation, selection, or configuration of one or more return buffers into which the operations write intermediate data during processing. In some examples, the graphics processor also uses one or more return buffers to store output data and to perform cross thread communication. In some examples, the return buffer state includes selecting the size and number of return buffers to use for a set of pipeline operations.

The remaining commands in the command sequence differ based on the active pipeline for operations. Based on a pipeline determination 2420, the command sequence is tailored to the 3D pipeline 2422 beginning with the 3D pipeline state 2430 or the media pipeline 2424 beginning at the media pipeline state 2440.

The commands to configure the 3D pipeline state 2430 include 3D state setting commands for vertex buffer state, vertex element state, constant color state, depth buffer state, and other state variables that are to be configured before 3D primitive commands are processed. The values of these commands are determined at least in part based on the particular 3D API in use. In some examples, 3D pipeline state 2430 commands are also able to selectively disable or bypass certain pipeline elements if those elements will not be used.

In some examples, 3D primitive 2432 command is used to submit 3D primitives to be processed by the 3D pipeline. Commands and associated parameters that are passed to the graphics processor via the 3D primitive 2432 command are forwarded to the vertex fetch function in the graphics pipeline. The vertex fetch function uses the 3D primitive 2432 command data to generate vertex data structures. The vertex data structures are stored in one or more return buffers. In some examples, 3D primitive 2432 command is used to perform vertex operations on 3D primitives via vertex shaders. To process vertex shaders, 3D pipeline 2422 dispatches shader execution threads to graphics processor execution units.

In some examples, 3D pipeline 2422 is triggered via an execute 2434 command or event. In some examples, a register write triggers command execution. In some examples execution is triggered via a ‘go’ or ‘kick’ command in the command sequence. In some examples, command execution is triggered using a pipeline synchronization command to flush the command sequence through the graphics pipeline. The 3D pipeline will perform geometry processing for the 3D primitives. Once operations are complete, the resulting geometric objects are rasterized and the pixel engine colors the resulting pixels. Additional commands to control pixel shading and pixel back end operations may also be included for those operations.

In some examples, the graphics processor command sequence 2410 follows the media pipeline 2424 path when performing media operations. In general, the specific use and manner of programming for the media pipeline 2424 depends on the media or compute operations to be performed. Specific media decode operations may be offloaded to the media pipeline during media decode. In some examples, the media pipeline can also be bypassed and media decode can be performed in whole or in part using resources provided by one or more general-purpose processing cores. In some examples, the media pipeline also includes elements for general-purpose graphics processor unit (GPGPU) operations, where the graphics processor is used to perform SIMD vector operations using computational shader programs that are not explicitly related to the rendering of graphics primitives.

In some examples, media pipeline 2424 is configured in a similar manner as the 3D pipeline 2422. A set of commands to configure the media pipeline state 2440 are dispatched or placed into a command queue before the media object commands 2442. In some examples, commands for the media pipeline state 2440 include data to configure the media pipeline elements that will be used to process the media objects. This includes data to configure the video decode and video encode logic within the media pipeline, such as encode or decode format. In some examples, commands for the media pipeline state 2440 also support the use of one or more pointers to “indirect” state elements that contain a batch of state settings.

In some examples, media object commands 2442 supply pointers to media objects for processing by the media pipeline. The media objects include memory buffers containing video data to be processed. In some examples, all media pipeline states must be valid before issuing a media object command 2442. Once the pipeline state is configured and media object commands 2442 are queued, the media pipeline 2424 is triggered via an execute command 2444 or an equivalent execute event (e.g., register write). Output from media pipeline 2424 may then be post processed by operations provided by the 3D pipeline 2422 or the media pipeline 2424. In some examples, GPGPU operations are configured and executed in a similar manner as media operations.

Program code may be applied to input information to perform the functions described herein and generate output information. The output information may be applied to one or more output devices, in known fashion. For purposes of this application, a processing system includes any system that has a processor, such as, for example, a digital signal processor (DSP), a microcontroller, an application specific integrated circuit (ASIC), a field programmable gate array (FPGA), a microprocessor, or any combination thereof.

The program code may be implemented in a high-level procedural or object-oriented programming language to communicate with a processing system. The program code may also be implemented in assembly or machine language, if desired. In fact, the mechanisms described herein are not limited in scope to any particular programming language. In any case, the language may be a compiled or interpreted language.

Examples of the mechanisms disclosed herein may be implemented in hardware, software, firmware, or a combination of such implementation approaches. Examples may be implemented as computer programs or program code executing on programmable systems comprising at least one processor, a storage system (including volatile and non-volatile memory and/or storage elements), at least one input device, and at least one output device.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, examples also include non-transitory, tangible machine-readable media containing instructions or containing design data, such as Hardware Description Language (HDL), which defines structures, circuits, apparatuses, processors and/or system features described herein. Such examples may also be referred to as program products.

### Emulation (Including Binary Translation, Code Morphing, etc.)

In some cases, an instruction converter may be used to convert an instruction from a source instruction set architecture to a target instruction set architecture. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

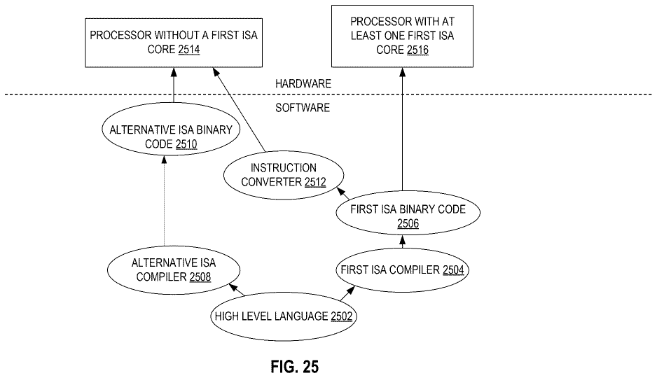

FIG. 25 is a block diagram illustrating the use of a software instruction converter to convert binary instructions in a source ISA to binary instructions in a target ISA according to examples. In the illustrated example, the instruction converter is a software instruction converter, although alternatively the instruction converter may be implemented in software, firmware, hardware, or various combinations thereof. FIG. 25 shows a program in a high-level language 2502 may be compiled using a first ISA compiler 2504 to generate first ISA binary code 2506 that may be natively executed by a processor with at least one first ISA core 2516. The processor with at least one first ISA core 2516 represents any processor that can perform substantially the same functions as an Intel® processor with at least one first ISA core by compatibly executing or otherwise processing (1) a substantial portion of the first ISA or (2) object code versions of applications or other software targeted to run on an Intel processor with at least one first ISA core, in order to achieve substantially the same result as a processor with at least one first ISA core. The first ISA compiler 2504 represents a compiler that is operable to generate first ISA binary code 2506 (e.g., object code) that can, with or without additional linkage processing, be executed on the processor with at least one first ISA core 2516. Similarly, FIG. 25 shows the program in the high-level language 2502 may be compiled using an alternative ISA compiler 2508 to generate alternative ISA binary code 2510 that may be natively executed by a processor without a first ISA core 2514. The instruction converter 2512 is used to convert the first ISA binary code 2506 into code that may be natively executed by the processor without a first ISA core 2514. This converted code is not necessarily to be the same as the alternative ISA binary code 2510; however, the converted code will accomplish the general operation and be made up of instructions from the alternative ISA. Thus, the instruction converter 2512 represents software, firmware, hardware, or a combination thereof that, through emulation, simulation or any other process, allows a processor or other electronic device that does not have a first ISA processor or core to execute the first ISA binary code 2506.

### IP Core Implementations

One or more aspects of at least some examples may be implemented by representative code stored on a machine-readable medium which represents and/or defines logic within an integrated circuit such as a processor. For example, the machine-readable medium may include instructions which represent various logic within the processor. When read by a machine, the instructions may cause the machine to fabricate the logic to perform the techniques described herein. Such representations, known as “IP cores,” are reusable units of logic for an integrated circuit that may be stored on a tangible, machine-readable medium as a hardware model that describes the structure of the integrated circuit. The hardware model may be supplied to various customers or manufacturing facilities, which load the hardware model on fabrication machines that manufacture the integrated circuit. The integrated circuit may be fabricated such that the circuit performs operations described in association with any of the examples described herein.

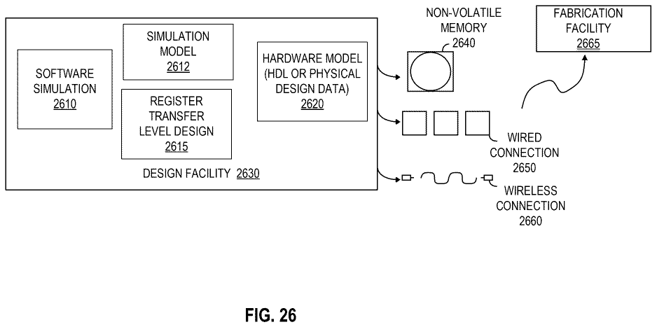

FIG. 26 is a block diagram illustrating an IP core development system 2600 that may be used to manufacture an integrated circuit to perform operations according to some examples. The IP core development system 2600 may be used to generate modular, re-usable designs that can be incorporated into a larger design or used to construct an entire integrated circuit (e.g., an SOC integrated circuit). A design facility 2630 can generate a software simulation 2610 of an IP core design in a high-level programming language (e.g., C/C++). The software simulation 2610 can be used to design, test, and verify the behavior of the IP core using a simulation model 2612. The simulation model 2612 may include functional, behavioral, and/or timing simulations. A register transfer level (RTL) design 2615 can then be created or synthesized from the simulation model 2612. The RTL design 2615 is an abstraction of the behavior of the integrated circuit that models the flow of digital signals between hardware registers, including the associated logic performed using the modeled digital signals. In addition to an RTL design 2615, lower-level designs at the logic level or transistor level may also be created, designed, or synthesized. Thus, the particular details of the initial design and simulation may vary.

The RTL design 2615 or equivalent may be further synthesized by the design facility into a hardware model 2620, which may be in a hardware description language (HDL), or some other representation of physical design data. The HDL may be further simulated or tested to verify the IP core design. The IP core design can be stored for delivery to a fabrication facility 2665 using non-volatile memory 2640 (e.g., hard disk, flash memory, or any non-volatile storage medium). Alternatively, the IP core design may be transmitted (e.g., via the Internet) over a wired connection 2650 or wireless connection 2660. The fabrication facility 2665 may then fabricate an integrated circuit that is based at least in part on the IP core design. The fabricated integrated circuit can be configured to perform operations in accordance with at least some examples described herein.

References to “some examples,” “an example,” etc., indicate that the example described may include a particular feature, structure, or characteristic, but every example may not necessarily include the particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described.

Examples include, but are not limited to:
1. A system comprising:
a first Peripheral Component Interconnect Express (PCIe) device to transmit transaction layer packets (TLPs) and integrity and data encryption sync (IDE_SYNC) messages to a second PCIe device; and
the second PCIe device to receive the TLPs and IDE_SYNC messages, wherein the second PCIe device is to perform at least one of a detection of a TLP reordering by a PCIe fabric based at least in part on when an IDE_SYNC message is received and/or a detection of an TLP ordering error when a TLP is received before a IDE_SYNC message that preceded it.
2. The system of example 1, wherein the first PCIe device comprises a transmitter counter and wherein the transmitter counter is to not be incremented until a IDE_SYNC message is sent.
3. The system of example 2, wherein the transmitter counter is to be reset to one after a IDE_SYNC message is sent.
4. The system of example 2, wherein the second PCIe device comprises an IDE_SYNC receiver logic to perform an ordering check before updating counters.
5. The system of any of examples 1-4, wherein the TLPs are non-posted (NP) TLPs.
6. The system of any of examples 1-4, wherein the TLPs are completion (CPL) TLPs.
7. The system of any of examples 1-6, wherein the first PCIe device is to set an overflow indication when a TLP sent counter reaches a set value and when a TLP is to be is to be transmitted when the TLP sent counter has the set value, the first PCIe device is to send an IDE_SYNC message before the TLP.
8. The system of example 7, wherein the second PCIe device is to increment a counter for a received IDE_SYNC message.
9. The system of example 7, wherein when a TLP arrives at the second PCIe device with a sent counter value of less than a set value and a posted request received counter is less than or equal to the set value, the second PCIe device is to decrement the sent counter value from the posted request received counter.
10. The system of example 7, wherein when a TLP arrives at the second PCIe device with a sent counter value of less than a set value and a posted request received counter is greater than or equal to the set value, the second PCIe device is to generate an error.
11. The system of example 7, wherein when a TLP arrives at the second PCIe device with a sent counter value of a set value the second PCIe device is to decrement an IDE_SYNC counter.
12. The system of example 1, wherein the first PCIe device is to block non-posted TLPs until all previous IDE_SYNC messages ahead of the non-posted TLPs are drained.
13. The system of example 12, wherein blocked non-posted TLPs have one of three states, where in a first state is a blocked state, a second state is a prepare state, and a third state is a ready state, wherein which state a non-posted TLP is in is dependent on a counter difference.
14. The system of example 13, wherein a non-posted tracker is to track non-posted TLP state.
15. The system of example 1, wherein the first PCIe device is to block completion TLPs until all previous IDE_SYNC messages ahead of the completion TLPs are drained.
16. A method comprising:
   transmitting, from a first Peripheral Component Interconnect Express (PCIe) device, a transmit transaction layer packet (TLP) and an integrity and data encryption sync (IDE_SYNC) message to a second PCIe device; receiving the transmitted TLP packet and IDE_SYNC message; and performing at least one of a detection of a TLP reordering by a PCIe fabric based at least in part on when an IDE_SYNC message is received and/or a detection of an TLP ordering error when a TLP is received before a IDE_SYNC message that preceded it.
17. The method of example 16, wherein the first PCIe device comprises a transmitter counter and wherein the transmitter counter is to not be incremented until the IDE_SYNC message is sent.
18. The method of example 17, further comprising: resetting the transmitter counter to one after the IDE_SYNC message is sent.
19. The method of example 17, further comprising: setting an overflow indication when a TLP sent counter reaches a v; and
   sending the IDE_SYNC message before a next TLP packet is sent and before a next CPL packet is sent.
20. The method of example 17, wherein when a TLP arrives at the second PCIe device with a sent counter underflows the receiver detects a reordering violation and signals an error.

Moreover, in the various examples described above, unless specifically noted otherwise, disjunctive language such as the phrase “at least one of A, B, or C” or “A, B, and/or C” is intended to be understood to mean either A, B, or C, or any combination thereof (i.e. A and B, A and C, B and C, and A, B and C).

The specification and drawings are, accordingly, to be regarded in an illustrative rather than a restrictive sense. It will, however, be evident that various modifications and changes may be made thereunto without departing from the broader spirit and scope of the disclosure as set forth in the claims.

What is claimed is:

1. A system comprising:
a first Peripheral Component Interconnect Express (PCIe) device to transmit transaction layer packets (TLPs) and integrity and data encryption sync (IDE_SYNC) messages to a second PCIe device; and
the second PCIe device to receive the TLPs and IDE_SYNC messages, wherein the second PCIe device is to perform at least one of a detection of a TLP reordering by a PCIe fabric based at least in part on when an IDE_SYNC message is received and/or a detection of an TLP ordering error when a TLP is received before a IDE_SYNC message that preceded it.

2. The system of claim 1, wherein the first PCIe device comprises a transmitter counter and wherein the transmitter counter is to not be incremented until a IDE_SYNC message is sent.

3. The system of claim 2, wherein the transmitter counter is to be reset to one after a IDE_SYNC message is sent.

4. The system of claim 2, wherein the second PCIe device comprises an IDE_SYNC receiver logic to perform an ordering check before updating counters.

5. The system of claim 1, wherein the TLPs are non-posted (NP) TLPs.

6. The system of claim 1, wherein the TLPs are completion (CPL) TLPs.

7. The system of claim 1, wherein the first PCIe device is to set an overflow indication when a TLP sent counter reaches a set value and when a TLP is to be is to be transmitted when the TLP sent counter has the set value, the first PCIe device is to send an IDE_SYNC message before the TLP.

8. The system of claim 7, wherein the second PCIe device is to increment a counter for a received IDE_SYNC message.

9. The system of claim 7, wherein when a TLP arrives at the second PCIe device with a sent counter value of less than a set value and a posted request received counter is less than or equal to the set value, the second PCIe device is to decrement the sent counter value from the posted request received counter.

10. The system of claim 7, wherein when a TLP arrives at the second PCIe device with a sent counter value of less than a set value and a posted request received counter is greater than or equal to the set value, the second PCIe device is to generate an error.

11. The system of claim 7, wherein when a TLP arrives at the second PCIe device with a sent counter value of a set value the second PCIe device is to decrement an IDE_SYNC counter.

12. The system of claim 1, wherein the first PCIe device is to block non-posted TLPs until all previous IDE_SYNC messages ahead of the non-posted TLPs are drained.

13. The system of claim 12, wherein blocked non-posted TLPs have one of three states, where in a first state is a blocked state, a second state is a prepare state, and a third state is a ready state, wherein which state a non-posted TLP is in is dependent on a counter difference.

14. The system of claim 13, wherein a non-posted tracker is to track non-posted TLP state.

15. The system of claim 1, wherein the first PCIe device is to block completion TLPs until all previous IDE_SYNC messages ahead of the completion TLPs are drained.

16. A method comprising:
transmitting, from a first Peripheral Component Interconnect Express (PCIe) device, a transmit transaction layer packet (TLP) and an integrity and data encryption sync (IDE_SYNC) message to a second PCIe device;
receiving the transmitted TLP packet and IDE_SYNC message; and
performing at least one of a detection of a TLP reordering by a PCIe fabric based at least in part on when an IDE_SYNC message is received and/or a detection of an TLP ordering error when a TLP is received before a IDE_SYNC message that preceded it.

17. The method of claim 16, wherein the first PCIe device comprises a transmitter counter and wherein the transmitter counter is to not be incremented until the IDE_SYNC message is sent.

18. The method of claim 17, further comprising:
resetting the transmitter counter to one after the IDE_SYNC message is sent.

19. The method of claim 17, further comprising:
setting an overflow indication when a TLP sent counter reaches a v; and
sending the IDE_SYNC message before a next TLP packet is sent and before a next CPL packet is sent.

20. The method of claim 17, wherein when a TLP arrives at the second PCIe device with a sent counter underflows the receiver detects a reordering violation and signals an error.
